(19) United States
(12) Patent Application Publication
(10) Pub. No.: US 2006/0273720 A1
(43) Pub. Date: Dec. 7, 2006

(54) CCFL device with a solid heat-dissipation means

(76) Inventor: Henry Yuk Ho Kwong, Hong Kong (HK)

Correspondence Address: KWONG, YUK HO HENRY, 11/F, MINERVA HOUSE, 34 LYTTELTON ROAD, MID-LEVELS, HONG KONG, HONG KONG, HK

(21) Appl. No.: 11/467,654

(22) Filed: Aug. 28, 2006

(51) Int. Cl. H01K 1/50

(52) U.S. Cl. 313/569

(57) ABSTRACT

A CCFL device using a heat-conductive compound that may also be light-transmitting to embed both its heat generating components, i.e., the electronic driver and the CCFL filament, so that there is no air trapped between these two heat sources and the outer surface of the device. The heat-conductive compound also forms its own surfaces that are exposed directly to air, so that the heat generated by the CCFL filament and the electronic driver is dissipated swiftly into the atmosphere. One embodiment of the present invention attaches the lamp filament support member to the integral ballast assembly, so it is no longer connected to the light-transmitting container in order to support the CCFL filament, thereby simplifies the manufacturing process significantly.

### BACKGROUND OF THE INVENTION

The present invention pertains particularly to an improved cold cathode fluorescent lamp (CCFL) device comprising at least one elongated CCFL that is bent into a pre-determined shape such as a spiral, double-spiral, multi-Us, and etc. The CCFL device of the present invention uses a heat-conductive compound comprising a synthetic material such as an epoxy, a resin or a silicone to embed its CCFL filament and its electronic driver, so that there is no air trapped between these respective heat sources and the outer surface of the device. The heat-conductive compound also forms its own surfaces that are exposed directly to air, so the heat generated by the driver is dissipated swiftly into the atmosphere. The lamp filament support member of the device is attached to the integral ballast assembly instead of the light-transmitting container, thereby simplifying the manufacturing process significantly.

A fluorescent lamp is a low pressure mercury vapor gas discharge device, which produces visible light when the phosphor layer coated on the inside of a hermetically sealed tubular glass bulb is activated by the ultraviolet radiation generated by an electron flow of a mercury vapor gas discharge formed within the tubular glass bulb when a proper electricity power is applied.

A plurality of electrodes are hermetically sealed into the tubular glass bulb of the fluorescent lamp for the purpose of starting and maintaining the electron flow when external electricity is applied to the electrical conducting wires linking at least one of the electrodes to the electronic driver that generates high voltage and high frequency electricity. These electrodes are designed for operating as either “hot” or “cold” cathodes, more correctly as “arc” or “glow” discharge electrodes, respectively. Fluorescent lamps having these two totally different discharge modes are commonly differentiated as the HCFL (hot cathode fluorescent lamp) and the CCFL (cold cathode fluorescent lamp), respectively.

The HCFL operates in arc discharge mode needs a large current usually in the order of 0.1 to 1.5 ampere to heat the tungsten coils attached to the “hot” cathodes to about 800.degree.C. to 1,000.degree.C., so that the electrons from the electron emissive layer, usually in the form of alkaline earth oxides coated onto the tungsten wire, are excited and leave the electrodes to form into an arc discharge. As such, the HCFL is also known as an arc discharge lamp, or arc lamp.

The life span of the HCFL ends when the electron emissive layer is nearly evaporated by the high temperature of tungsten wire. The stress on its tungsten wire during the lamp's on-off instant is so severe that when the device is flashing continuously, or when it is turned on and off frequently, the tungsten wire breaks easily. The tungsten wire of HCFL also has a limited life as it weakens continuously by its own continuous evaporation, same as the tungsten wire of an ordinary incandescent light bulb. These disadvantages render the HCFL a relatively short-life lighting device, with life span of usually a few thousands hours.

Another disadvantage of the HCFL is that its light output cannot be dimmed smoothly, as the tungsten wire needs a stable and high temperature to be maintained in order for it to continuously emit electrons from the electron emissive layer. The HCFL can therefore only be dimmed stepwise using complicated and expensive electronic circuitry.

The CCFL emits electrons by a totally different mechanism from that of the HCFL, by making use of a high cathode-fall voltage usually of at least 100V between the cathodes to pull ions into the gas discharge. This commonly known “grow” discharge mechanism is driven mainly by high frequency (10 k-150 kHz) AC electricity of several hundred to a few thousand volts at start, and of 500-2,500 volts during operation. As the cathode-fall voltage needs to be high in order to obtain high efficacy and high power for general lighting purposes, the elongated lamp body of the CCFL is preferably more than one meter long.

The CCFL wastes no power to heat up the electrode during the start of the lamp. There is no evaporable tungsten, so its life span can be much longer than the HCFL, usually up to 50,000 hours or more.

The CCFL can operate on a continuous flashing mode, because of its “cold” electrode is usually formed of a coiled nickel plate with a large surface area that never evaporates or weakens as the tungsten wire of the HCFL does. The CCFL starts instantly (usually less than 10 milliseconds) even under low ambient temperature, due mainly to the fact that, unlike the HCFL, it does not need to heat up the tungsten wire to at least 800.degree.C. during start, which usually takes a several hundred milliseconds.

Moreover, given the high operating voltage, dimming of the light output for the CCFL can be performed smoothly and instantly by reducing the voltage either gradually or swiftly to any desirable level using an ordinary wall dimmer.

Both the HCFL and the CCFL have existed for long time. They have many different applications and a large variety of products available in the market. As such, their comparative advantages and disadvantages, as well as their completely different technical aspects, are well known to people familiar with the art. It is therefore beyond doubt that the HCFL and the CCFL are essentially totally different lamp devices, even they share the same feature in exciting the mercury vapor to generate ultraviolet radiation for the phosphor layer to emit light.

Included here for reference purposes, there are detailed descriptions of the differences between the HCFL and the CCFL in the book “Flat Panel Displays and CRTS” by Lawrence E. Tannas, Jr., (Von Nostrand Reinhold, New York, 1985), in the paper entitled “Efficiency Limits for Fluorescent Lamps and Application to LCD Backlighting,” by R. Y. Pai, (Journal of the SID, May 4, 1997, pp. 371-374), and in the descriptions of prior arts contained in U.S. Pat. No. 5,834,889, granted to Ge, Nov. 10, 1998; U.S. Pat. No. 6,135,620, granted to Marsh, Oct. 24, 2000; and U.S. Pat. No. 6,515,433, granted to Ge, et al., Feb. 4, 2003.

The HCFL normally needs at least 10 times bigger diameter tubing than that of the CCFL in order to maintain high light generation efficiency when operating at high power. This is because it operates in an arc discharge mode, where a large amount of excited electrons are generated. If the tubing diameter is too small, the mercury plasma will absorb an excessively higher proportion of the electrons, thereby weakens the mercury plasma's overall output of ultraviolet radiation, and ultimately reduces the device's light generation efficiency. For this reason, the HCFL uses tubing of usually over 10-20 mm in diameter, and of lengths normally between 6-12 cm. Glass tubes of such a configuration normally have sufficient strength on their own to withstand mechanical shocks and strong vibrations.

Unlike the HCFL, the CCFL typically works most efficiently when the inner diameter of its filament is about 0.6-1.5 mm, and for it to work at higher power, the length must be over 100 cm in order to raise the cathode-fall voltage to sufficiently high levels. As such, the CCFL must be long and thin. However, even the elongated and thin tabular filament is bent into a spiral or other shapes, its thin glass body can still be easily broken, despites the overall mechanical strength of the lamp body after bending into a spiral has improved comparing to being in a stretched-out elongated form.

Due to the physical fragility of the elongated lamp filament of the CCFL, a CCFL device cannot normally be acceptable for general lighting applications in a bare lamp form factor without a light-transmitting container or a layer or coating of light-transmitting mater substantially embedding the lamp filament inside, mainly for safety reasons. Moreover, being coverless also raises another unpleasant shortcoming, as phototactic insects would be trapped and died inside the narrow pitches of the exposed lamp filament spiral.

In order to protect the thin CCFL filament from mechanical and vibration shocks, also to enable the CCFL device to look similar to an ordinary light bulb, it is therefore desirable and necessary to enclose it within a light-transmitting container, preferably a small glass bulb of an ordinary incandescent light bulb.

However, the CCFL filament generates considerable heat under an enclosed environment where heat is not easily dissipated. This causes the temperature within the container to rise significantly and stops the CCFL gas discharge device to function efficiently, due to the peculiar behavior of the mercury vapor as explained below.

Both the CCFL and the HCFL are low mercury vapor pressure gas discharge devices, therefore they share most of features at their post-electron generation activities. In particular, they share the same light-generating mechanism by having the mercury molecules being excited by the electrons to a higher energy state, from which they return to the ground state and produce ultraviolet radiation. The ultraviolet radiation is absorbed by the phosphor layer on the CCFL filament wall, and is finally converted into visible light and heat. During the ultraviolet radiation generation phase, the mercury gas discharge works efficiently (i.e., generates the optimum amount of ultraviolet energy) only when the coolest spot of the CCFL is within a temperature range of about 25-75.degree.C. Above this temperature range, the excessive heat will cause the mercury ions to become overly active so that the mercury vapor pressure within the CCFL increases.

As explained in a pioneer research titled “Amalgams for fluorescent lamps”, by Bloem, et al., published in the Philips Technical Review (Volume 38, 83-88 1978/79 No. 3), the mercury vapor pressure is an important parameter for a low pressure mercury discharge device, and it is usually determined by the coolest part on the wall of the lamp. If this pressure is too low, few mercury molecules are excited, meaning insufficient ultraviolet radiation falls on the phosphor layer. If it is too high, the mercury molecules absorb much of their own radiation and more of them become in excited states, and there becomes a greater probability of interactions involving non-radiative transfer of their excitation energy, so less ultraviolet energy lands on the phosphor layer.

On page 23 of the book “Electric discharge lamp” by J F Waymouth (MIT Press Cambridge Mass. 1971), it is told that the optimum mercury vapor pressure is approximately 6×10.sup.-3 torr, a value reached when the coolest spot on the wall of the lamp is about 40.deg.C. Nevertheless, with mercury vapor pressure at between about 3×10.sup.-3 torr and 9×10.sup.-3, the lamp's light output efficiency is still within an acceptable level that is not too noticeably different from the optimal light output level at mercury vapor pressure of about 6×10.sup.−3 torr.

Owing to the peculiar behavior of the mercury vapor explained in the above, the luminous efficacy of the CCFL falls sharply when the body temperature of the lamp filament becomes overheated with the increase of electricity power input, particularly when the CCFL device lacks an efficient heat dissipation means when being enclosed in a light-transmitting container. In order for a CCFL device to be output light optimally without losing efficacy, the coolest lamp wall temperature must be kept at about 25-75.degree.C. It is therefore desirable to provide an improved CCFL device that has highly efficient heat-dissipation means for its CCFL filament, allowing the coolest wall temperature of the filament be kept at said optimal range when it is operating at high electricity power input. The present invention provides a satisfactory solution that overcomes such heat-dissipation difficulty for the CCFL device, by embedding the lamp filament in a solid light-transmitting and heat-conductive compound, so that the heat generated by the lamp filament is passed to the outer surface of the device and dissipated swiftly into the atmosphere.

Another major shortcoming of the CCFL is that the electronic driver has a high-voltage transformer which is highly vulnerable to heat damages. For a conventional CCFL device, the heat dissipated by the CCFL filament always cause the electronic driver to fail as the latter usually connects to the CCFL electrodes at a short distance. For example, a conventional CCFL powered at 8-13 watt enclosed within a light-transmitting container lacking an effective heat-dissipation means would have a temperature of 90-120.degree.C. for the space surrounded by the CCFL spiral. Such excessive heat generated by the CCFL, together with the heat generated by the components of electronic driver, if not being properly dissipated, affects the life span of the electronic driver adversely.

Unlike the HCFL, the electronic driver of the CCFL is more vulnerable to damages by overheating because it comprises a high-voltage transformer in its circuitry that generates about 500-2,500 volt of AC electricity at a frequency of 10k-150 kHz. This transformer, because of the limited space available for the electronic driver, is usually of a small form factor, therefore must use very thin copper wire usually of diameter less than 0.1 mm wrapping a few hundred to over a thousand turns around a small bobbin. Because of the high voltage, this transformer needs extra insulation and effective heat dissipation means, otherwise it fails easily and destroys the entire electronic driver. As the life span of a CCFL filament itself normally exceeds 50,000 hours, it is therefore highly desirable to provide an improved CCFL gas discharge device that has an efficient heat-dissipation means for the electronic driver.

Conventional electronic driver design for the CCFL is to attach all electronic components on either one or both sides of a printed circuit board, which is then disposed inside a plastic housing attached between the light-transmitting container and the lamp base. As such, plentiful space is left unoccupied within the housing and the lamp base. Owing to the bulkiness of such conventional design, it needs a large plastic driver housing, which becomes even larger because of the housing itself has a wall thickness of at least 1.5 mm on its entire circumference.

Another disadvantage of the conventional CCFL device that uses a driver housing to connect to both the light-transmitting and the lamp base is that the driver housing cannot be made of metal, as it will be electrically conductive after attached to the lamp base. However, a plastic or ceramic driver housing is a poor heat conductor, especially when plentiful air is trapped inside its unoccupied space. This causes the electronic driver inside to be easily over-heated. It is therefore desirable to eliminate the housing for the electronic driver but not exposing it uncovered.

The assembly of conventional CCFL gas discharge device usually involves a series of steps of firstly affixing the lamp filament to a lamp filament support member. The light-transmitting container is then attached to the first opening of the lamp filament support member. Following that, the housing for the electronic driver is attached to the second opening of the lamp filament support member. Finally the lamp base is attached. Such an assembly method is entirely inefficient as it does not allow jumping between, or combining the steps involved.

Moreover, unlike the HCFL, the CCFL has a thin filament body, so when its legs are inserted into a lamp filament support member, it often tilts away from an upright position. The alignment becomes even more difficult when the lamp filament support member is connected to the light-transmitting container. Then two more alignments are necessary when the housing for the electronic driver and the lamp base are attached. These alignment jobs are often frustrating, because every alignment must be done properly and carefully. If any one misalignment causes the filament to tilt, all others alignments have to be redone from scratch. To overcome such a difficulty, it is desirable to eliminate the number of alignment jobs, particularly to avoid the alignment that involves with connecting the lamp filament support member to the light-transmitting container.

Finally, there are wide applications of the HCFL plug-in lamps with G23 G24 or G24d electrical connectors, and of the HCFL T5, T8, T9 and T12 lamps with G5, G13 or R17d bi-pin electrical connectors, particulary in positions such as ceilings and lamp posts that are difficult to reach. The short life span of the HCFL is therefore causing significant difficulties owing to the frequent replacement needs, as well as high positions that are difficult to reach. Moreover, these HCFL devices are not dimmable by ordinary wall dimmers. As such, it is highly desirable to have long-life and dimmable alternatives for them provided for by the CCFL type of T5, T8, T9 and T12 lamps and the CCFL type of plug-in lamps using G23 G24 or G24d electrical connectors, which can operate at high electricity power input.

### BRIEF SUMMARY OF THE INVENTION

In order to overcome the afore-described shortcomings and difficulties of the CCFL devices aiming for general lighting uses and for operation with high electricity power input, an object of the present invention is to provide an improved CCFL gas discharge device with a compact form factor, that has a similar shape and dimension of a conventional incandescent light bulb, that can overcome the heat dissipation difficulties for the electronic driver and the CCFL filament, that can be cost effectively assembled without requiring to align the CCFL filament more than twice, and that can generate high intensity illumination when operating at high electricity power input.

An object of present invention is to provide a CCFL device with an integral ballast assembly that has a lamp filament support member supporting the CCFL filament on its topmost surface. Such an integral ballast assembly is formed by a heat-conductive compound filling the space between the electronic driver and the lamp base, so that heat generated by the electronic driver is dissipated swiftly into the atmosphere. The heat is also swiftly conducted away through the lamp base that is mechanically attached to a conventional socket which has a metallic surface connecting to a pair of copper conducting wires.

Forming the integral ballast assembly in the above manner allows a lamp filament support member to be attached to its top that is facing away from the lamp base. This lamp filament support member can be glued to the top of the integral ballast assembly by adhesives, or it may have a plurality of legs or extrusions on its side facing away from the attached CCFL filament, that are bonded integrally with the integral ballast assembly.

No matter how it the lamp filament support member is being attached to the integral ballast assembly, it supports and affixes the CCFL filament onto the top of the integral ballast assembly, so that the lamp filament support member is no longer necessary to be connected to the light-transmitting container in order to support the CCFL filament. This eliminates the most difficult job of aligning the CCFL filament within a CCFL device, thereby greatly simplifies the manufacturing process.

Otherwise, the lamp filament support member has to be connected to the light-transmitting container in order to support the CCFL filament, or it must be attached to the light-transmitting container directly, both methods are still within the scope of this invention although such arrangements are less preferred.

A detachable and water-tight mold of a pre-determined shape is used for filling the heat-conductive compound. Before filling the heat-conductive compound, the electronic driver in the form of one or several modules is placed securely inside the mold, together with a lamp base comprising a shell with a plurality of insulated portions each has a contact electrically coupled to the electronic driver. Then a heat-conductive compound comprising a synthetic material such as an epoxy or a resin is filled inside the mold, so that the electronic driver is integrally embedded.

After the mold is detached, an integral ballast assembly is formed that has an assembly of heat-conductive compound extending through and filling the interior of the shell of the lamp base, and the assembly also forms at least one surface of its own, in addition to another surface that is provided by the shell of the lamp base. In order to further improve the heat dissipation swiftness, at least one surface formed by the heat-conductive compound is exposed directly to air.

The integral ballast assembly formed in the manner described above does not have a casing or housing for itself, and its surfaces are either exposed to air or are mechanically and thermally connected to a high thermal conductivity surface of the conventional power socket.

The term “assembly” is used herein for such a structure of the ballast, not only because the heat-conductive compound is forming integrally with the electronic driver and the lamp base into an integral assembly, but also because it has no outer wall at all. Otherwise, housing always defines its boundary by its outer wall. Besides, the electronic driver is embedded integrally inside the assembly, it cannot be retrieved or replaced, unlike being put inside a housing where it can be taken out and put back in.

The assembly of heat-conductive compound comprises a synthetic material such as an epoxy or a resin that provides superior electrical insulation to the high-voltage transformer of the electronic driver, apart from serving as a thermal bridge between the components of the electronic driver and the lamp base.

There are many other benefits of forming the integral ballast assembly in the above manner. For instance, the electronic driver is now placed at a further distance (than in the case of being placed inside a housing that is attached to the light-transmitting container) from the CCFL electrodes, which are the main heat source that affects the electronic driver adversely. This enables the CCFL device to lower the operating temperature of its electronic driver, so it can have a longer operating life.

Moreover, it is no longer necessary to dispose the electronic driver in a separate housing that is attached to the light-transmitting container.

Using a housing for the electronic driver is undesirable, as the housing has a minimum wall thickness of about 1.5 mm, so that the inner space within the housing for the electronic driver is substantially reduced. Besides, such housing is attached directly to the lamp base, so it must be made of plastic or ceramic materials that are poor heat conductors. Most importantly, with housing for the driver, air is trapped inside, causing the electronic driver inside to be overheated easily.

Using the novel methods of the present invention to form the integral ballast assembly, the container connection member is separated and insulated from the lamp base by the heat-conductive compound, so it can be made of metallic material, therefore allows the heat generated by the CCFL electrodes to be dissipated swiftly to the atmosphere, and lesser heat will be passed to the electronic driver inside the integral ballast assembly. This reduces the temperature of the electronic driver and increases the useful life of the CCFL device. This arrangement is much better than separating the CCFL filament and the electronic driver by a conventional air gap, which is difficult to assembly, causes the device to have an unpleasant outlook, and easily traps insets and dusts inside the air gap.

Using the above novel method to form the integral ballast assembly, the lamp filament support member is attached rigidly with the integral ballast assembly. It is therefore no longer necessary to connect to the light-transmitting container in order to support the CCFL filament. This means only two alignment processes are needed during the manufacture of the CCFL device, i.e., when the legs of CCFL filament is affixed to the cavities of the lamp filament support member, and when the light-transmitting container is attached to the container connection member. These two processes normally do not interfere with each other. As such, the most difficult job of aligning the CCFL filament within a CCFL device is eliminated, thereby greatly simplifies the manufacturing process.

After the integral ballast assembly attached with a lamp filament support member is formed with the heat-conductive compound, only two remaining assembly processes are left, i.e., (a) attach the CCFL filament to the lamp filament support member mechanically and electrically, and (b) attach the light-transmitting container and the integral ballast assembly to the first and the second openings of a container connection member, respectively.

Another object of the present invention is to further simplify the assembly of the CCFL device by forming an integral ballast assembly that is connected rigidly with a container connection member and a lamp filament support member. This is accomplished by disposing the legs or extrusions of the lamp filament support member, the container connection member, the electronic driver and the lamp base securely inside a specially designed mold before the heat-conductive compound is filled inside.

In another embodiment of the present invention, no lamp filament support member is used, as the legs of the CCFL filament are bonded directly to the bottom of the light-transmitting container by using bonding agents such as a silicone adhesive, a low melting point soldering glass, or other heat enduring adhesives. The container connection member for this embodiment has a plurality of bigger cavities so that the bottom of the light-transmitting container together with the bonded legs of the lamp filament can be inserted.

In still another embodiment of the present invention, the lamp filament support member is connected to the light-transmitting container in order to support the CCFL filament inside the container. This is not a preferred embodiment of the present invention, although is the conventional way of forming the lamp body that comprises the light-transmitting container, the CCFL filament and the lamp filament support member. By using the integral ballast assembly of the present invention for such a conventional lamp body, it can still enjoy swift heat dissipation benefits for the electronic driver attached.

In another preferred embodiment, a two-parted mold is used to form the integral ballast assembly so that its container connection cavity and/or lamp filament support cavities are of similar shape and functionality as the one using separately fabricated container connection member and/or a lamp filament support member. In this manner, the entire integral ballast assembly is formed from a specially made mold that has an internal shape same the integral ballast assembly that has a separately fabricated container connection member and/or a lamp filament support member.

Another embodiment of the present invention provides a hermetical sealing and a high thermal conductivity gas to the CCFL devices which do not already have a hermetically sealed light-transmitting container that is enclosing a high thermal conductivity gas inside. This is accomplished by forming a hermetical sealing between the container connection member and the bottom of the light-transmitting container by using a low melting point soldering glass or other vacuum adhesives, so that the internal space bonded by the internal surfaces of the light-transmitting container and the contain connection member can store the high thermal conductivity gas. Naturally, if there are other connections between the container connection member and the integral ballast assembly that is not already hermetically sealed, such connections must also be hermetically sealed by using the same low melting point soldering glass or other vacuum adhesives. With the high thermal conductivity gas stored inside the container, the heat generated by the CCFL filament can be dissipated swiftly to the atmosphere, thereby improving the luminous intensity of the device and reducing the heat transferred to the integral ballast assembly.

Nevertheless, in order to evacuate air and to fill in the heat-conductive gas, during the formation of the integral ballast assembly, a small exhaust tube must be embedded inside the integral ballast assembly before the heat-conductive compound is filled inside the mold. This exhaust tube has one end at the filament connection side of the integral ballast assembly, and the other end at a side position immediately next to the shell of the lamp base. In order for the hermetical seal to be lasting, the small exhaust tube is preferably made of heat contractible plastic so that when sealed by flame after the high-conductivity gas is filled it, it contracts into the inside of the integral ballast assembly, and the small hole left at its original opening on the side surface of the integral ballast assembly is sealed by epoxy or other vacuum adhesives.

Another embodiment of the present invention has the CCFL filament embedded inside a solid light-transmitting compound that is in thermal contact with the CCFL filament. This extends the benefit of embedding the electronic driver with a heat-conductive compound to the CCFL filament, which is of the same scope of the present invention. As explained before, the optimum output of a CCFL filament is affected substantially by the coolest spot on the wall of its filament. If the filament is insulated by air inside the light-transmitting container, the heat generated by the filament will not be dissipated swiftly to the atmosphere, and will significantly reduce the luminous efficiency of the CCFL filament.

Embedding the CCFL filament within a solid light-transmitting compound would eliminate the air trapped between the filament and the outer surface of the device, so heat generated by the filament can be dissipated swiftly into the atmosphere. This provides a satisfactory solution to solve the heat dissipation problem of the CCFL device. Such a solid light-transmitting compound comprises a synthetic material such as clear epoxy, transparent silicone or other resins. However, as it is heavy, it is more preferred for tubular shaped light-transmitting containers with small internal diameters.

The use of a high thermal conductivity gas such as the hydrogen and the helium gas hermetically sealed within the light-transmitting container helps to solve the heat dissipation difficulty of the CCFL device. However, even the hydrogen gas has the best thermal conductivity amongst all high thermal conductivity gaseous, it is still far less thermally conductive than many solid light-transmitting compounds. Besides, filling a solid light-transmitting compound inside the light-transmitting container can avoid with the tedious and expensive air evacuation and helium/hydrogen injection processes.

In a preferred embodiment, a solid light-transmitting compound is filled inside the entire space of a single walled light-transmitting container.

In another preferred embodiment, the light-transmitting container of the CCFL device is doubled walled, and the CCFL filament is sandwiched in the space between the two walls. A solid light-transmitting compound comprising a synthetic material such as clear epoxy, transparent silicone or other resins is filled in between the two walls. For such a device, either the inner or the outer surface of the inner shell can also be coated with a reflective material, in order to reflect more light through the outer light-transmitting shell.

In case a double walled light-transmitting container is used, it is normally of cylindrical or cone shape, and the CCFL filament is placed at a shorter distance from the outer shell, so faster heat-dissipation can be achieved. Such a CCFL device can operate at a higher electricity power input.

With the solid light-transmitting compound embedding the CCFL filament and attaching it to the surface of the light-transmitting container, it is no longer necessary to use a lamp filament support to fix the position of the lamp filament within the device, thereby simplifies the assembly process significantly.

In another preferred embodiment, the solid light-transmitting compound embeds the CCFL filament integrally inside by using a mold, so a light-transmitting container is no longer necessary, as the solid light-transmitting compound forms its own light-transmitting surface after detached from the mold, and this surface is directly exposed to air. Such a device allows the heat generated from the CCFL filament to be dissipated even faster.

As the solid light-transmitting compound is heavy, the above embodiments that use such a compound is preferred to have a tubular shaped light-transmitting container with small diameters; or else the device is in a tubular shape, in case the solid heat-conductive compound forms its own surface using a mold.

Moreover, for such devices, the CCFL filament is preferably coated with a soft light-transmitting material substantially along its length, so that the different coefficients of expansion of the hardened solid light-transmitting compound and the glass envelope of the CCFL filament will not create excessive pressure on the CCFL filament embedded inside. In this case, the CCFL filament is embedded within at least two different solid light-transmitting compounds, with a softer layer of such a compound sandwiched between the outer layer of solid light-transmitting compound and the CCFL filament.

In another preferred embodiment, the CCFL filament is covered on its outer surface with a transparent shatter-resistant silicone coating. There are many commercially available shatter-resistant coating materials that serve the requirement of the present invention satisfactorily, such as the fluoropolymer material of the Teflon family products like PTFE and FEP. The protective coating, apart from providing enhanced mechanical strength to the CCFL filament, will also contain the glass fragments in case the filament is broken. With such a thin coating, normally of less than 0.5 mm, the heat generated by the lamp filament can swiftly be dissipated into the atmosphere, particularly when the coating is punched with multiple tiny holes to allow the hot air trapped inside the spiral filament to be released outside. With such a coating, it may not be necessary to enclose the CCFL filament within a light-transmitting container.

In still another preferred embodiment, the embedding the CCFL filament inside a solid light-transmitting compound as described above is extended to the plug-in lamps and tubular lamps that do not have a electronic driver integrated with the devices. These CCFL plug-in lamps of the present invention are preferable alternatives to the ordinary HCFL plug-in lamps of 1U, 2U, 4U, 6U, and etc. shapes which use the G23, G24 or G24d bi-pin or quad-pin electrical connectors as lamp bases. Similarly, the CCFL tubular lamps are also preferable alternatives for the HCFL T5, T8, T9 and T12 fluorescent lamps, which use G5, G13 or R17d bi-pin electrical connectors.

There are wide applications of the HCFL plug-in lamps with G23 G24 or G24d electrical connectors, and of the HCFL T5, T8, T9 and T12 lamps with G5, G13 or R17d bi-pin electrical connectors, particularly in positions such as ceilings and lamp posts that are difficult to reach. The short life span of the HCFL is therefore causing significant difficulties owing to the frequent replacement needs, as well as their high positions that are difficult to reach. Moreover, these HCFL devices are not dimmable by ordinary wall dimmers. As such, it is more preferred to replace them by the above novel models of CCFL type of T5, T8, T9 and T12 lamps and the CCFL type of plug-in lamps using G23 G24 or G24d electrical connectors, which can operate at high electricity power input for a much longer life span, are dimmable, and have unbreakable lamp bodies.

All the above and other objects, features, and advantages of the present invention will become apparent from the following detailed description of the different embodiments of the present invention, the accompanying drawings, and the enlisted claims. While not specifically described, it is understood that many of the features in the different embodiments may be used separately or in conjunction. Thus, the light-transmitting container of a small form factor may be A-shaped, pear-shaped, candelabra-shaped, globe-shaped, cylindrical-shaped, cone-shaped, MR16, MR103, and any other shapes commonly taken on by an ordinary incandescent light bulb. The material used to form the container can be glass, plastic, resin or metal coated with a reflective inner surface, or a combination of these different materials.

Similarly, the CCFL filament can be bent into different shapes of U's, serpentine, cone, spiral, double-spiral and the like, so that the ultimate gas discharge fluorescent device has a small form factor of shape and size similar to an incandescent light bulb.

Additionally, each of the embodiments may employ more than one CCFL filament. In cases where two or more filaments are used, each may generate light of the same or different colors. The CCFL devices may be used for illumination, decoration, traffic lights or display devices. All Such variations are within the scope of the present invention.

### BRIEF DESCRIPTION OF THE SEVERAL VIEWS OF THE DRAWINGS

The foregoing summary and the following detailed description of the invention will be better understood when read in conjunction with the accompanying drawings. For the purpose of illustrating the present invention, only the presently preferred embodiments are shown in the drawings, but it should be understood that the invention is by no means limited to the precise arrangements and instrumentalities shown in the drawings, which are briefly introduced below:

FIG. 1 is a cross sectional view of a prior-art compact HCFL fluorescent lamp taught by the U.S. Pat. No. 5,164,635 granted to De Jong, et. al. on Nov. 17, 1992.

FIG. 2 is a cross sectional view of a prior-art luminescent element of a CCFL lamp type CFD according to the U.S. Pat. No. 5,834,889 granted to Ge Xiaoqin on Nov. 10, 1998, and also according to the U.S. Pat. No. 6,211,612 granted to Ge Xiaoqin on Apr. 3, 2001.

FIG. 3(a) and FIG. 3(b) are a perspective view and a cross sectional view, respectively, of a prior art A-shaped CCFL lamp according to the U.S. Pat. No. 6,135,620 granted to Marsh, Brent on Oct. 24, 2000.

FIG. 4 is a side elevation view of a prior-art CCFL device with a container for housing the CCFL and with a housing for the driver, according to the U.S. Pat. No. 6,515,433 issued to Ge, et al. on Feb. 4, 2003.

FIG. 5 it is a partially cross-sectional and partially perspective view of a prior art CCFL device the US Patent Application 20050275351 filed by Ge, Shichao on Feb. 9, 2005 and published on Dec. 15, 2005.

FIG. 6(a)-FIG. 6(c) are cross sectional views of a two-part detachable and water-tight mold used to form an integral ballast assembly according to Embodiment 1 of the present invention, together with the components for this integral ballast assembly.

FIG. 7(a) is the cross sectional view of an integral ballast assembly with a container connection member and a lamp filament support member, formed by the components and mold of FIG. 6(a)-Fig(c), and FIG. 7(b) and FIG. 7(c) are semi-assembled and fully-assembled CCFL devices using the integral ballast assembly, container connection member and lamp filament support member of FIG. 7(a).

FIG. 8 is a cross sectional view of a CCFL device with the container connection member attached to integral ballast assembly in such a manner that its bottom is connected to the mouth line of the shell of the lamp base, and no surface of the integral ballast assembly is exposed to air.

FIG. 9 is a cross sectional view of a CCFL device that has its lamp filament support member attached the container connection member, which is in turn attached to the top of the integral ballast assembly.

FIG. 10 is a cross sectional view of a CCFL device that has its container connection member and lamp filament support member combined into a single unit that is attached to the top of the integral ballast assembly.

FIG. 11(a)-FIG. 11(b) are cross sectional views of a two-part detachable and water-tight mold used to form an integral ballast assembly according to Embodiment 2 of the present invention, together with the components for this integral ballast assembly.

FIG. 12 is the cross sectional view of a fully assembled CCFL device with its lamp filament attached to the lamp filament support member that is formed integrally with the integral ballast assembly, and with its light-transmitting container attached to the container connection member that is also formed integrally with the integral ballast assembly.

FIG. 13(a) to FIG. 13(d) are cross sectional views of the components and a fully assembled structure of another CCFL device that has its lamp filament attached to the lamp filament support member that is formed integrally with the integral ballast assembly, and has its light-transmitting container attached to the container connection member that is also formed integrally with the integral ballast assembly.

FIG. 14(a) to FIG. 14(d) are cross sectional views of the components and a fully assembled structure of still another CCFL device of candelabra shape that has its lamp filament attached to the lamp filament support member that is formed integrally with the integral ballast assembly, and has its light-transmitting container attached to the container connection member that is also formed integrally with the integral ballast assembly.

FIG. 15(a) to FIG. 15(c) are cross sectional views of the components and a fully assembled structure of a CCFL device that has its lamp filament attached to the lamp filament support member formed integrally with the integral ballast assembly, and has its light-transmitting container attached directly to the lamp base so that the container connection member can be omitted.

FIG. 16(a) to FIG. 16(c) are cross sectional views of the components and a fully assembled structure of a CCFL device that has its lamp filament attached to the inner bottom surface of the light-transmitting container, which is then attached to a container connection member integrally formed with the integral ballast assembly, and the lamp filament support member is omitted.

FIG. 17 is the cross sectional view of another fully assembled structure of a CCFL device that has its lamp filament attached to the inner bottom surface of the light-transmitting container, and that has a large cap with its container connection member that is extending into the inner space bounded by the double-spiral shaped CCFL filament.

FIG. 18(a)-(b) are cross sectional views of a two-part detachable and water-tight mold used to form an integral ballast assembly according to Embodiment 5 of the present invention, together with the components for this integral ballast assembly.

FIG. 19 is the cross sectional view of a fully assembled CCFL device according to Embodiment 5 using the components and the integral ballast assembly formed from those of FIG. 18(a)-(b).

FIG. 20(a)-(b) are cross sectional views of a two-part detachable and water-tight mold used to form an integral ballast assembly according to Embodiment 6 of the present invention, together with the components for this integral ballast assembly.

FIG. 21 is the cross sectional view of a fully assembled CCFL device according to Embodiment 6 using the components and the integral ballast assembly formed from those of FIG. 20(a)-(b).

FIG. 22 to FIG. 30 are cross sectional views of the fully assembled CCFL devices similar to those formed according to Embodiments 1 to 6, but they all have a hermetically sealed inner space bonded by the inner surface of the light-transmitting container, the container connection member (if any) and the integral ballast assembly, and that said inner space is filled with a high thermal conductivity gas.

FIG. 31 is the cross sectional view of a cylindrical shaped CCFL device that has a double-walled container filled with a high thermal conductivity gas between its outer container wall and inner container wall.

FIG. 32 is the cross sectional view of the same cylindrical shaped CCFL device of FIG. 31 except that a solid light-transmitting compound is filled between its outer container wall and inner container wall.

FIG. 33 is the cross sectional view of the same CCFL device of FIG. 32 except that it has a conical shaped container and it has a reflective surface on its inner container wall.

FIG. 34(a) is the cross sectional view of a CCFL device with a tubular lamp body housing a double spiral CCFL filament, and with a solid light-transmitting compound filled entirely inside the tubular light-transmitting housing; and FIG. 34(b) is the same device of FIG. 34(a) except that it has an inner shell this is coated with a reflective layer on its surface.

FIG. 35 is the cross sectional view of a CCFL device with a tubular lamp body that is formed entirely from the solid light-transmitting compound by using a mold, so that the device does not have a light-transmitting container housing the CCFL filament.

FIG. 36(a)-(d) are cross sectional view and top views of a plug-in lamp with a 4-pin G24/G24d-type electrical connector attached to two, three or four tubular lamp bodies each having a double spiral CCFL filament inside embedded by a solid light-transmitting compound.

FIG. 37(a) is the cross sectional view of a plug-in lamp with a 4-pin electrical connector attached to the tubular lamp body that is filled with a solid light-transmitting compound inside; and FIG. 37(b) is the cross sectional view of another plug-in lamp with a different 4-pin electrical connector attached to the tubular lamp body that is filled with a solid light-transmitting compound inside.

FIG. 38 is a perspective and semi-cross sectional view of a CCFL T8 tubular device with a 3-U linear CCFL filament housing inside the T8 light-transmitting container that is filled with a solid light-transmitting compound inside.

FIG. 39 is the cross-sectional view of a CCFL T12 tubular device that has two 3-U linear filaments housing inside the T12 light-transmitting container, which contains a solid light-transmitting compound inside.

FIG. 40 and FIG. 41 are same devices as that of FIG. 39, but has instead six linear CCFL filaments are housing inside the T12 light-transmitting container that contains a solid light-transmitting compound inside. They differ in the way the electrodes are connected to the bi-pin connectors at both ends of their tubular containers.

### DETAILED DESCRIPTION OF THE INVENTION

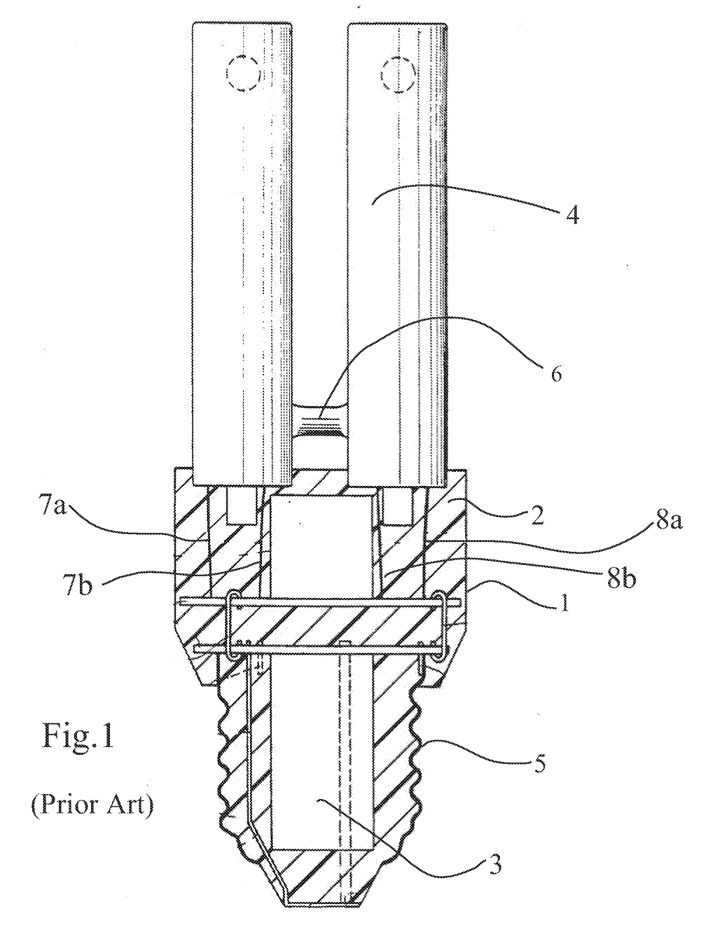

Hereinafter, the details of the present invention and its preferred embodiments are described with reference to the accompanying drawings. For simplicity in description, in the accompanying drawings except the drawings of prior arts referred to in FIG. 1 to FIG. 5, identical components are labeled by the same numerals, from 101 onward.

Before detailing the present invention with its various preferred embodiments, five prior arts deemed most closely related to the subject matter of the present invention are described below, together with the drawings referring to FIG. 1 to FIG. 5 that are illustrating these arts.

Prior Art 1

Referring to FIG. 1, the compact fluorescent lamp taught by the U.S. Pat. No. 5,164,635 granted to De Jong, et. al. on Nov. 17, 1992 by has an integral ballast assembly 1 formed of synthetic material 2 in which an electronic driver 3 comprising circuitry for operating the lamp is included. The light source 4 drawn is a hot cathode compact low-pressure mercury discharge lamp with a quadruple lamp vessel which has a fluorescent powder coating, and its end portion is integrally embedded in the synthetic material 2 of assembly 1. A lamp base 5 is fastened to the assembly 1. The electronic driver 3 is embedded in a synthetic material 2 which fills the assembly 1. The synthetic material 2 at the same time constitutes the assembly 1 itself.

The electric lamp of the U.S. Pat. No. 5,164,635 is a HCFL device as the lamp body shown in the only one drawing of is typically of a hot cathode lamp body which has a large diameter and a short length. As written in the description of the U.S. Pat. No. 5,164,635, the lamp body has quadruple lamp vessels, which are connected by the tubular 6 as clearly indicated in FIG. 1. Such a connection is typical of a hot cathode lamp body, as its diameter is large enough for the tubular 6 to connect the internal space of all its member vessels. Most importantly, it is marked clearly in FIG. 1 that there are two conductors 7a and 7b leading from the end portion of first lamp vessel to the electronic driver 3. There is also another pair of conductors 8a and 8b leading from the end portion of another lamp vessel to the electronic driver 3. Only the HCFL devices have two conductors for each of the two ends of its multiple lamp vessels that are communicated internally within their internal space by such hollow tubular as the tubular 6 shown in FIG. 1. As the electric lamp of the Prior Art 1 is a HCFL device, such an invention is therefore of an entirely different scope form the present invention.

Prior Art 2

An invention of a CCFL device that has a compact lamp body similar to an incandescent light bulb is taught by the U.S. Pat. No. 5,834,889 granted to Ge Xiaoqin on Nov. 10, 1998, and by its continuation of the U.S. Pat. No. 6,211,612 granted to Ge Xiaoqin on Apr. 3, 2001. According to these two US patents, the CCFL filament of the CCFL device is supported by a lamp filament support member or by a base plate that is connected to the light-transmitting container, and the electrical connector (i.e., a lamp base or its equivalent) of the device is mechanically coupled to the light-transmitting container. As explained before, by attaching the CCFL filament to a support member or base plate that is connected to the light-transmitting container requires at least 4 alignments of the CCFL filament in order to ensure the filament is in its upright position during the manufacturing process. Moreover, by mechanically coupling the lamp base to the light-transmitting container, only a very small size CCFL lamp filament can be inserted into the container, and in such cases, the CCFL device can hardly generate sufficient luminous intensity for general lighting applications.

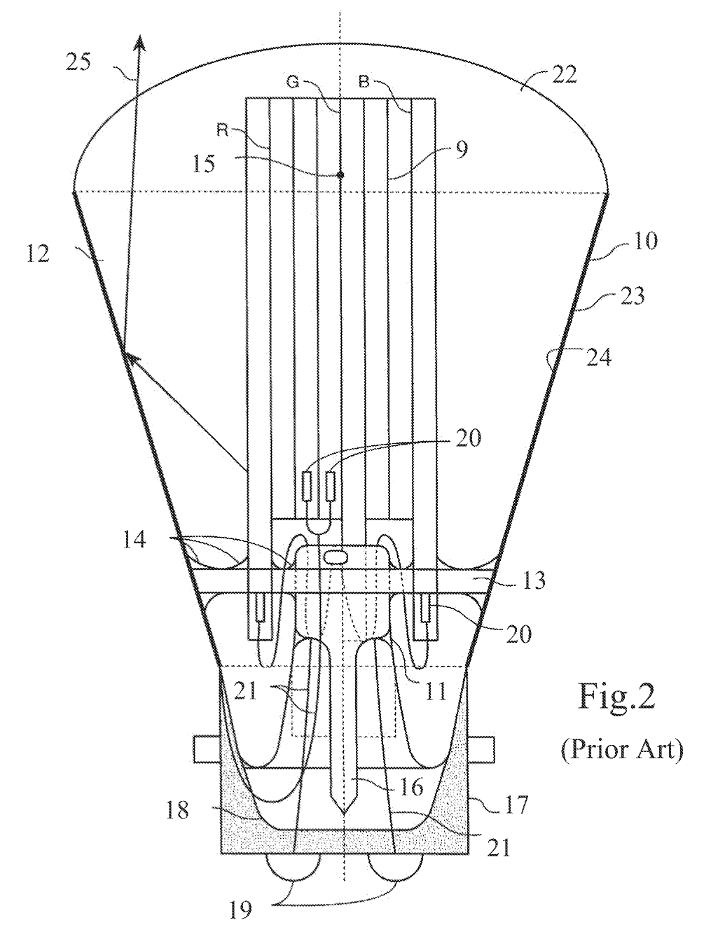

In fact, the two afore-mentioned patents granted to Ge Xiaoqin are mainly aiming for CCFL devices that are for display uses. As such, there is no electronic driver included in the device, and it relies upon an external driver order to operate the CCFL housing inside its light-transmitting container. The drawing of such a device, referred to as a luminescent element for a CFD (cold cathode display) device, as illustrated in FIG. 2, is re-produced from the specifications of these two patents. The descriptions of FIG. 2, in quotes below, are also extracted from the same source, but the numerals marking the components of the device in the drawing and referred to in the descriptions are re-arranged to conform to the numbering sequence of the present invention.

Referring to FIG. 2, it shows the luminescent elements of a CCFL lamp type CFD according to the two afore-mentioned patents that are granted to Ge Xiaoqin. “9 is the CCFL. For the monochromatic or white/black displays, 9 is at least one shaped white or monochromatic CCFL. For the multi-color display, 9 includes at least one group of multi-color CCFLs. For the full-color display, 9 includes at least one group of R, G, B three primary color CCFLs as shown in FIG. 2. 10 is a glass tube. 11 is a lamp base which is preferably sealed within the glass tube 10 to form a vacuum chamber 12. Alternatively, chamber 12 may be filled with a gas, such as nitrogen or an inert gas. 13 is a base plate [also referred herein as a lamp filament support member] on which the CCFLs are fixed. The base plate 13 is fixed on the lamp base 11 and its edge is attached to the internal surface of the glass tube 10. To obtain a good fixing and sealing effect, an adhesive 14 such as ceramic adhesive is applied between/among the base plate 13, the glass tube 10, the lamp base 11 and the CCFLs. If the CCFL is more than one piece between the CCFLs, these CCFLs are also fixed to each other by a vacuum adhesive 15. As shown in FIG. 2, most of the light emitted by CCFL 9 is transmitted through tube 10 except for light directed towards base plate 13, which also preferably has a light reflective surface to reduce the light lost.”

“16 is an exhaustion tube for exhausting the gas in the vacuum chamber 12. 17 is a lamp head which is fixed to the lamp base [also referred herein as the electrical connector] by a fixing adhesive 18. 19 are connectors of the lamp. 20 are electrodes of the CCFLs; these electrodes are connected to the connector 19 and the lamp head 17 through leads 21. The glass tube 10 can be a diffusing glass tube to obtain a diffusing light. Alternatively, the glass tube 10 shown in FIG. 2 has a front face 22 and a backside 23. The front face 23 is a transparent or a diffusing spherical surface and the backside 23 is a cone shape or a near cone shape tube.”

“On the internal surface of the backside 23 of the glass tube, there is a reflective film 24, e.g., an Al, Ag, or alloy thin film, to reflect the light and to increase the luminance of the lamp shown as 25 when viewed from the top in FIG. 2. The vacuum chamber 12 can reduce the heat loss of the CCFL and hence increase the efficiency of the CCFL. In addition, the vacuum chamber 12 can also eliminate any undesirable effects caused by the ambient temperature on the characteristics of CCFL. The base plate 13 is a high reflective plate to reflect the light and to increase the luminance of the CFD. Some of the CCFL lamps shown in FIG. 2 can be used for making the monochromic, multi-color, full-color display system to display character, graphic or video images. The CCFL lamps can be also used for the purposes of illumination. If the CCFL lamps are used for such purpose, reflective film or layer 24 would be omitted so that the backside 23 of tube or container 10 also transmits light.”

Prior Art 3

Another invention of a CCFL device that has a compact lamp body similar to an incandescent light bulb is taught by the U.S. Pat. No. 6,135,620 granted to Marsh, Brent on Oct. 24, 2000. It teaches “a CCFL illuminated A-lamp shaped light bulb, bulb utilizing a main power source, the bulb comprising a CCFL, the CCFL being elongated and having a predetermined length and geometric configuration . . . There is an A-lamp shaped body portion, the A-lamp shaped body portion made of a suitable transparent material. There is a CCFL mounting means, the CCFL mounting means grasping the CCFL securely for mounting within the A-lamp shaped body portion. There is a ballast means, the ballast means comprising an electrical circuit . . . There is a bulb mounting socket base portion . . . comprising a plurality of electrical contacts, the contacts connected to the input to the ballast, the contracts configured as in the contacts on the base of a conventional incandescent A-lamp light bulb.”

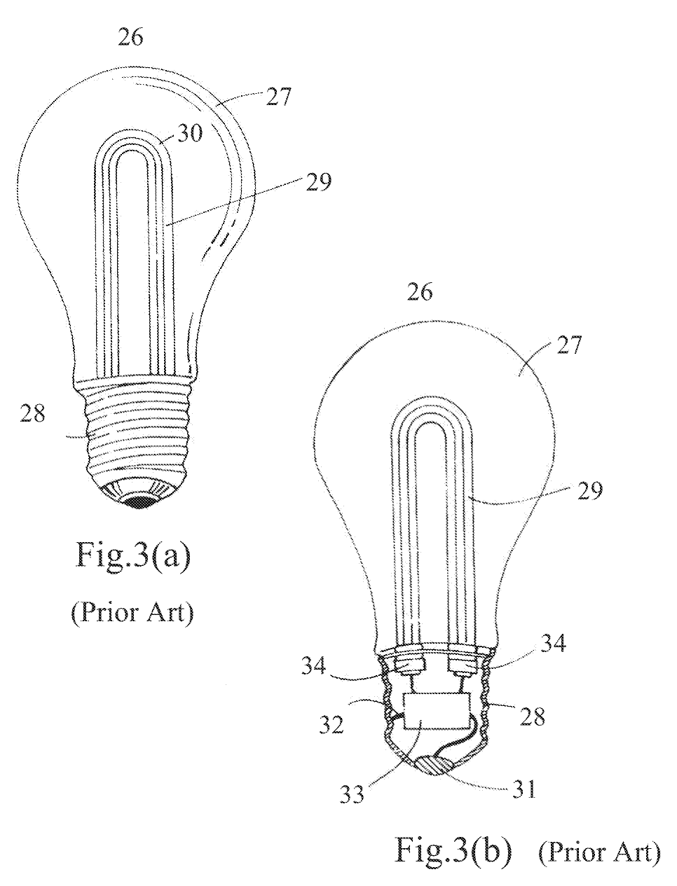

FIG. 3(a) and FIG. 3(b) herein reproduced the drawing of said A-lamp shaped CCFL light bulb taught by Marsh's patent above. This is by far the earliest invention known to the art for a bulb-shaped CCFL device, and is now a pubic domain subject matter as Marsh has not made any claims on such a device in his patent. Nevertheless, the said device taught by Marsh does not have any heat-conductive material to form integrally with the electronic driver resting inside the lamp base, and there is no disclosure of what the mounting means is and how it is supporting (mounting) the CCFL within the device. Moreover, same as the previously mentioned US Patents granted to Ge Xiaoqin, Marsh's teaching also seals the lamp base to the A-shaped bulb. This too will restrict the light-transmitting container to house only a smallish CCFL filament that may not produce sufficient light for general lighting purposes.

Referring to FIG. 3(a), it is a perspective view of an A-lamp light bulb 26 of the invention of Marsh described in the above, and as extracted from the description of Marsh's patent paper, it is told that: “The A-lamp shape is well known and the electrode configuration with the socket is well known. Thus, by providing the same shape bulb portion 27, the invention will be immediately useful wherever common incandescent bulbs are used. The base portion 28 is the same size and shape as the common incandescent bulb socket portion. The CCFL lamp 29 has a single U-shaped bend in the middle. A plurality of bends or CCFL lamps of different geometries would also be within the scope of the present invention and would be known to those skilled in the art. It will also be understood that a tubular housing 30 may or may not be necessary to desirable, depending upon the end use of the bulbs, optional use of diffusion materials in the lamp, housing or bulb portions, etc.”

Referring to FIG. 3(b), it shows a cross section of “the A-lamp light bulb 26 with CCFL device, associated electronics and internal mounting means of the present invention. In cross section, the bulb portion 27 is coupled to the base portion 28. The base portion is comprised of a first 31 and a second 32 electrically-isolated low-voltage electrodes which are integral with the threaded mounting socket base portion. These low-voltage electrodes are designed to electrically couple with the line power of the standard A-lamp light or appliance socket. The ballast means 33 will be small enough to be placed in the base portion of the bulb. Connected to the ballast are the CCFL electrodes 34 which extend from either end of the U-shaped CCFL lamp 29.”

Prior Art 4

The U.S. Pat. No. 6,515,433 issued to Ge, et al. on Feb. 4, 2003 teaches, amongst other features, the use of a housing for the electronic driver. For such conventional CCFL device, it is undoubtedly convenient to have a housing to enclose the electronic driver. However, there is a plurality of major draw backs that have been explained in the preceding description of the present invention. It is therefore an object of the present invention to avoid the housing for the electronic driver by embedding the driver inside an assembly of heat-conductive material that also integrates with the lamp base.

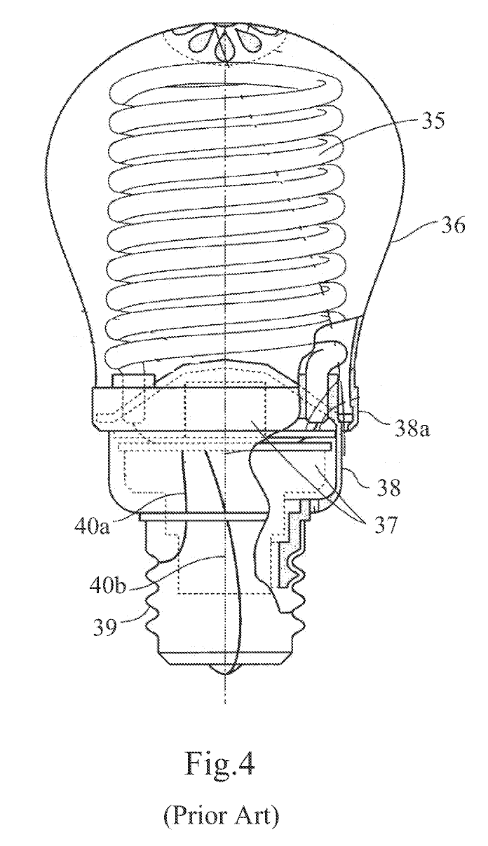

Referring to FIG. 4, its shows “a side elevation view of a CCFL device with a container for housing the CCFL and a housing for the driver. Both the container and the housing have a hole to enhance heat dissipation. The device includes a CCFL filament 35 in the shape of a spiral. CCFL 35 is contained in the chamber formed by a transparent or light diffusive container 36. Driver 37 is contained in the housing 38 which is connected to container 36 to form a chamber for holding the CCFL 35. Part 38a is the top portion of housing 38. Driver 37 is electrically connected to an electrical connector 39 of a conventional type usually seen on incandescent lamps by means of wires 40a and 40b. Electrical connector 39 is connected to a power source (not shown) in the same manner as is done conventionally for incandescent lamps. Driver 37 is electrically connected to CCFL 35 by wires 41a and 41b. Therefore, when appropriate power is applied to connector 39, driver 37 will apply the appropriate power to CCFL 35 causing gas discharge in the CCFL in order to generate light.”

Prior Art 5

US Patent Application 20050275351 filed by Ge, Shichao on Feb. 9, 2005 and published on Dec. 15, 2005 teaches a CCFL device which has a lamp support pole along the length of the filament of an elongated CCFL so that it does not need an outer shield (i.e., a light-transmitting container), and the CCFL filament is exposed entirely to air while the device operates with high electricity input.

Moreover, the key limitation of the claim of the above US Patent Application 20050275351 is that “the lamp support pole has a surface, wherein the CCFL is attached to the surface at a plurality of locations along its length so that the lamp is substantially fixed a position relative to the surface”; or that the device has “at least one cold cathode fluorescent lamp having a predetermined shape for supplying light, and a lamp support attached to and supporting the cold cathode fluorescent lamp so that the cold cathode fluorescent lamp has said predetermined shape”.

None of the above two limitations of the claims of the US Patent Application 20050275351 are limiting any embodiment of the present invention. Although the present invention also uses a lamp filament support member to support the CCFL within the device, said lamp filament support member does not have a surface for the CCFL to be substantially fixed at a position relative to the surface. The lamp filament support member used in the present invention is only attached to the legs of the CCFL, in the same manner as many conventional CCFL devices in the prior arts do. Besides, the lamp filament support member of the present invention does not has a predetermined shape conforming to the predetermined shape of the CCFL, as it does not support the CCFL along the latter's length.

Moreover, the CCFL device taught by the US Patent Application 20050275351 is one without a light-transmitting container housing the CCFL inside. Such an open structure, is not able to protect the fragile CCFL filament from damages by external mechanical impacts, and also easily trap phototactic moths and insects that die insides into the pitches of the spiral filament.

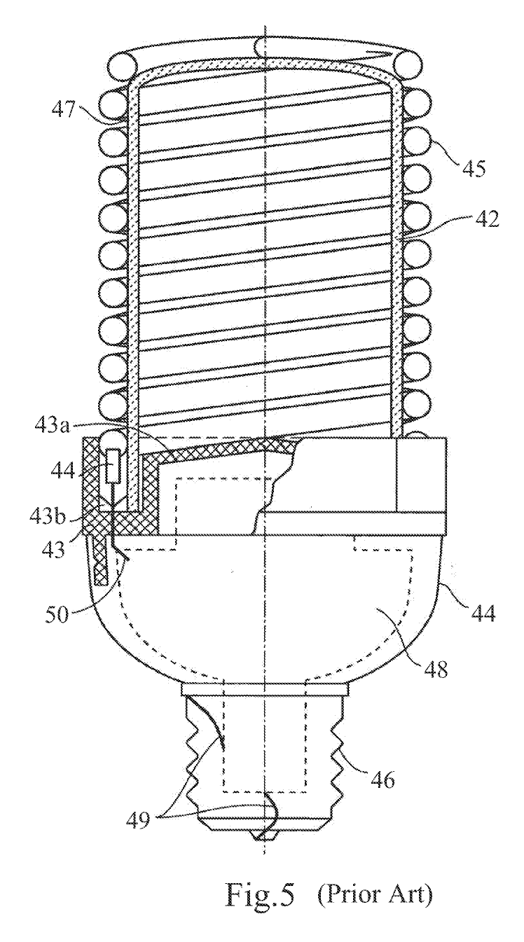

Referring to FIG. 5, it is a partially cross-sectional and partially perspective view of a CCFL device of the above US Patent Application 20050275351 that has “at least one CCFL, at least one lamp support, a driver, a driver housing and an electrical connector. The lamp support 42 is attached to the upper portion 43 of the driver housing 44. Top portion 43 has a groove 43b for housing electrodes 44 of the CCFL 45 to fix the position of the electrodes relative to the housing 44, with an air gap between the electrodes 44 and the main body of the housing 44. Housing 44 is in turn attached to electrical connector 46 so that housing 44, connector 46 and support 42 form a substantially rigid structure for increased mechanical strength, and thereby also forming an integral or unitary body.”

“The CCFL 45 is attached to the surface of lamp support 42 by means of adhesive 47 at a plurality of locations so that the mechanical strength of the CCFL is greatly increased and does not rely solely on the mechanical strength of the lamp itself. Furthermore, because of the rigid structure formed by the housing 44, connector 46 and support 42, the entire CCFL lighting device has great mechanical strength and does not require an outer shell or container for protection from external forces in the environmental. Furthermore, since no outer shell shields the CCFL, the lighting device of FIG. 5 has great heat dissipation capabilities and the heat generated by the CCFL 45 does not significantly raise the temperature of the driver 48. The top portion 43 can have a light reflective layer 43a facing the CCFL 45 to reflect light directed to the housing outwards for illumination purposes. Driver 48 may be connected through wires 49 to electrical connector 46 for connection to an outside power source (not shown). Connector 46 may be one of many different types of conventional electrical connectors. The output power of driver 48 is supplied through wires 50 to the CCFL electrodes 44.”

As explained in the above, these prior arts deemed most closely related to the subject matter of the present invention are not able to provide a satisfactory solution to solve the difficulties of a CCFL device operating at high electricity power while being enclosed inside a light-transmitting container. Besides, the structure for the CCFL device taught by these prior arts is difficult to manufacture. For the devices of these prior arts that attach the lamp base or electrical connector to the light-transmitting container, they are not able to house a sufficiently large CCFL filament that is able to generate sufficient luminous intensity for general light purposes. It is an object of the present invention to overcome such unresolved difficulties and to provide a novel CCFL device that is easy to manufacture, as detailed in the following embodiments of the present invention.

### Embodiment 1

The first embodiment the present invention provides a CCFL device that has an integral ballast assembly attached with a lamp filament support. Said integral ballast assembly is formed by filling a heat-conductive compound within a detachable mold so that the entire space between the electronic driver and the lamp base are filled with the heat-conductive compound air-tightly. As a detachable and water-tight mold of a pre-determined shape is used to fill the heat-conductive compound, there is no need for a housing to enclose the electronic driver, as the assembly of heat-conductive compound forms its own surfaces after detached from the mold. It is preferred that at least one surface of the assembly of heat-conductive compound connecting to the shell of the lamp base is exposed to air, so that the heat from the assembly can be dissipated directly into the atmosphere. A metallic container connection member is also preferred as it is insulated from the metallic shell of the lamp base, and can help to dissipate the heat from the integral ballast assembly more swiftly.

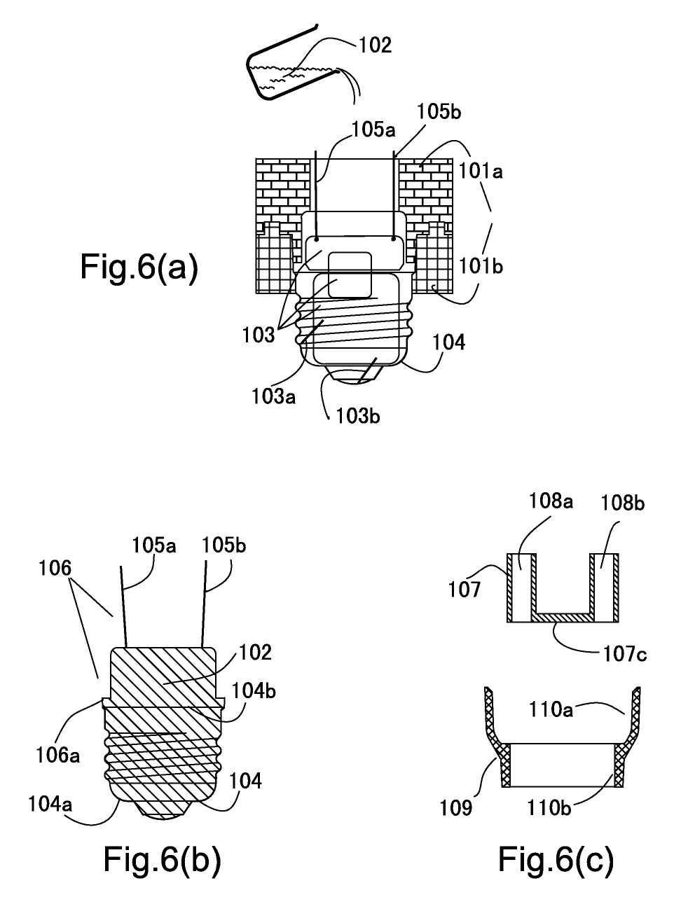

Referring to FIG. 6(a), a two-part detachable and water-tight mold 101, with upper-part mold 101a and lower-part mold 101b is used for filling the heat-conductive compound 102 by hand or by using a vertical type plastic/resin injection machine (not shown). Before filling in the heat-conductive compound 102, the different modules of the electronic driver 103 is properly connected and securely disposed inside a two-part mold 101, with connectors 103a and 103b electrically and mechanically coupling the electronic driver 103 to a contact in each of the at least two insulated portions of the lamp base 104. Two conductors 105a and 105b are leading from the output end of the electronic driver 103, and they are for connection to the electrodes of the CCFL filament in order to supply high-voltage high frequency electricity to the CCFL filament for it to emit light.

Referring to FIG. 6(b), the integral ballast assembly 106 is formed after detached from the mold 101 (not shown), its entire surfaces, apart from the surface of the metallic shell 104a of the lamp base 104 that is integrally connected to it, are formed from the heat-conductive compound 102 that comprises a synthetic material, such as an epoxy, a silicone, a plastic, a synthetic resin, and etc.

A major benefit of forming the integral ballast assembly by a detachable and water-tight mold provides the flexibility of attaching different types of lamp bases, which can be of a conventional Edison lamp base, or other newer designs such as GU10, GU34, half-height screw base, etc. The lamp base can be placed inside the mold before the heat-conductive compound is filled in, or attached later after the integral ballast assembly is formed before connecting to the lamp base.

One other benefit of forming the integral ballast assembly according to the present invention, is that it eliminates the need of housing for the electronic driver. As explained before, said housing is undesirable as it causes the electronic driver to be easily overheated. Another benefit is to allow the electronic driver be fabricated in a multi-module format instead of a single piece, so that it can be placed flexibly to fill most of the space available within the mold and the lamp base. As there is no wall for the integral ballast assembly apart from the thin metallic cap of the lamp base, the overall size of the ballast assembly can be substantially reduced. This also reduces the amount of heat-conductive compound to be used, as well as the heat path of the electronic components to reach to the outer surface of the integral ballast assembly.

Again referring to FIG. 6(b), after the heat-conductive compound 102 is cured or cooled down, the mold 101 (not shown) is detached, and integral ballast assembly 106 is formed. It has no casing, as the hardened heat-conductive compound 102 forms its entire outer surface that is above the month line 104b of the lamp base 104, and below this mouth line 104b, the outer metallic surface of shell 104a of lamp base 104 becomes its own surface. At least one surface 106a of the assembly 106 of heat-conductive compound 102 connecting to the mouth line 104b of shell 104a of the lamp base 104 is exposed to air, so that the heat from the assembly can be dissipated directly into the atmosphere.

Also referring to FIG. 6(b), the heat-conductive compound 102 is serving as a thermal bridge between the components of the electronic driver 103 and the lamp base 104. The lamp base 104 serves as a heat sink with the threads of its screws acting as fins allowing heat to dissipate directly to the lamp sockets and electricity mains, both of which have high copper/metal contents and therefore have superior thermal conductivities. There is no insulating air trapped inside, the integral ballast assembly 106 is therefore a highly efficient heat radiating body, and it also has the portion 106a of its surface directly exposed to air. The heat-conductive compound 102 also provides superior insulation and protection to the high-voltage transformers of the electronic driver 103, allowing the integral ballast assembly 106 to extend its life span substantially.

After forming the integral ballast assembly with lamp filament support in the above manner, it becomes much easier to assemble the entire CCFL device. All it needs is to attach the CCFL filament mechanically to the lamp filament support member after the electrical conductors are electrically coupling the electrodes of CCFL filament to the electronic driver, and then to attach both the light-transmitting container and the integral ballast assembly to both sides of a container connection member by a bonding agent, which comprises silicone gel such as RTV, low melting point soldering glass or other heat-enduring adhesives.

The container connection member is preferably formed of metal such as aluminum, although it can also be formed of other materials such as plastic, glass or ceramic. One major benefit of forming the integral ballast assembly by the insulative heat-conductive compound is to enable the container connection member be formed of metal, as it is insulated from the metallic lamp base.

With a metallic container connection member connecting the light-transmitting container and the integral ballast assembly, heat from the lower part of the CCFL filament, particularly from the electrodes, can be radiated and conducted swiftly to the atmosphere and by the surface of the metallic connection member, so lesser heat will be passed to the electronic driver. This reduces the temperature of the electronic driver and increases the useful life of the CCFL device. This arrangement is much better than separating the CCFL filament and the electronic driver by a conventional air-gap, which is difficult to assembly, causes the device to have an unpleasant outlook, and easily traps insets and dusts inside the gap.

Referring to FIG. 6(c), the lamp filament support member 107 has two prong-type cavities 108a and 108b for receiving a CCFL filament that has prong-type legs. On its other side that is facing away from the prong-type cavities 108a and 108b, the surface 107c has a planer shape smaller than the outer surface at the top of the integral ballast assembly 106, and has two holes communicating to cavities 108a and 108b so that the connectors 105a and 105b protruding from the top of assembly 106 can pass through. Also referring to FIG. 6(c), the container connection member 109 is a structure of a pre-determined shape, with an inner surface on its first opening 110a that is similar in shape but slightly bigger than the outer surface of the bottom of a light-transmitting container that will be fitted into this opening 110a. The second opening 110b of the container connection member 109 also has an inner surface similar in shape but slightly bigger than the top of the integral ballast assembly 106 that is pointing away from the lamp base 104.

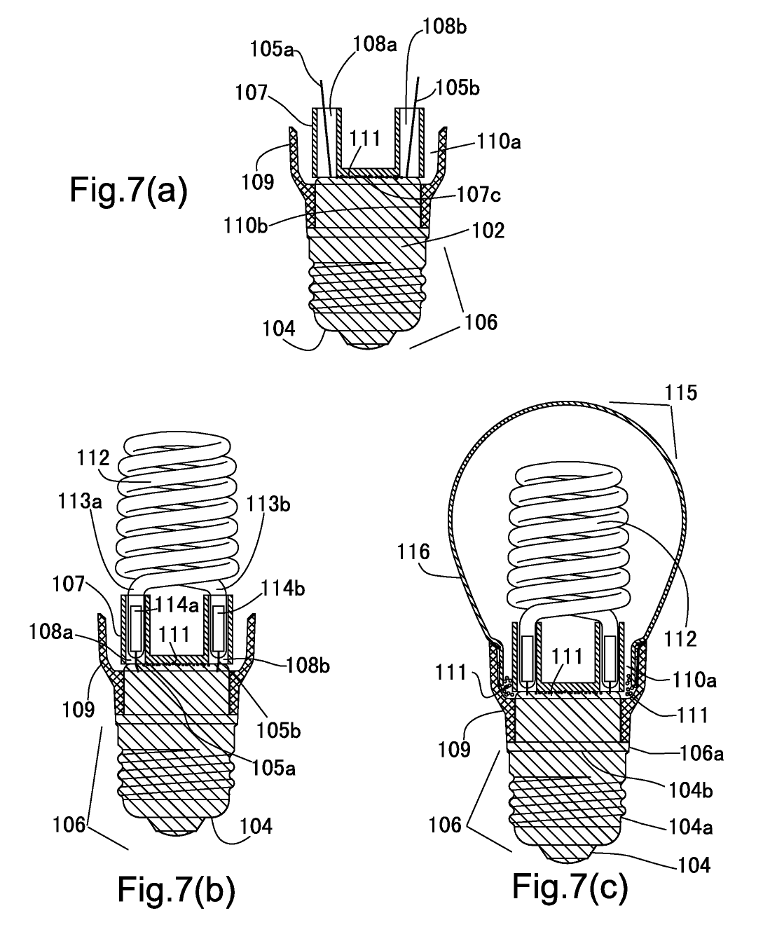

Referring to FIG. 7(a), it shows the opening 110b of the container connection member 109 is rigidly connected to the top of the integral ballast assembly 106, and the opening 107c of the lamp filament support member 107 is also securely attached to the further top of the integral ballast assembly 106, by glue or bonding agent 111 that comprises adhesives such as silicone gel, RTV or other heat-enduring adhesives. The two connectors 105a and 105b of the integral ballast assembly 106 pass through the prong-type cavities 108a and 108b of the lamp filament support member 107, respectively.

Referring to FIG. 7(b), the CCFL filament 112 is securely attached to lamp filament support member 107, with its two prong-type legs 113a and 113b disposed in the prong-type cavities 108a and 108b of support member 107, and with the lead wires leading from its electrodes 114a and 114b coupled to the connectors 105a and 105b of the integral ballast assembly 106. In this manner, the CCFL filament 112, the lamp filament support member 107, the container connection member 109 and the integral ballast assembly 106 are securely connected together to form a rigid structure.

Referring to FIG. 7(c), it shows the fully assembled CCFL device 115 according the present invention, after the light-transmitting container 116 is inserted into the opening 110a of the container connection member 109, and their connecting surfaces are glued together by the bonding agent 111, which comprises adhesives such silicone gel, RTV, low melting point soldering glass or other heat-enduring adhesives. At least one surface 106a of the integral ballast assembly 106 connecting to the mouth line 104b of the shell 104a of lamp base 104 is exposed to air, so that the heat from the assembly can be dissipated directly into the atmosphere. The container connection member 109 is also separated and insulated from the lamp base 104 by the surface 106a. As such, container connection member 109 can be formed of metal such as aluminum, so that the heat from the attached integral assembly 106 is dissipated more swiftly to the atmosphere through its surface.

In forming the integral ballast assembly using the method described above, the electronic driver is placed at a further distance away from the CCFL electrodes than is in the case of being placed inside a housing attached to the light-transmitting container. This enables the electronic driver to operate with lower ambient temperature and therefore can have a longer operating life.

The integral ballast assembly formation according to the present invention provides a novel means to isolate the lamp filament support member from the light-transmitting container, thereby eliminates the most difficult filament alignment process mentioned in the above. As the lamp filament support member is attached integrally with the integral ballast assembly, it is no longer necessary to be connected to the bottom of the light-transmitting container in order to support the CCFL filament inside the container. As such, only two alignments are needed during the assembly of the CCFL device, i.e., when the legs of CCFL filament is affixed to the cavities of the lamp filament support member, and when the light-transmitting container is attached to the container connection member. These two processes normally do not interfere with each other.

The novel method of forming the integral ballast assembly described in the above entirely solves the lamp filament alignment problem for the CCFL device. At the same time, it also provides an effective heat dissipation means for the electronic driver embedded inside the integral ballast assembly. Nevertheless, The method of forming the integral ballast assembly described in the above may have many obvious variations that provide similar functionalities that serve the same purpose of easing the alignment job and providing efficient heat dissipations for the electronic driver. The more preferred variations are described below.

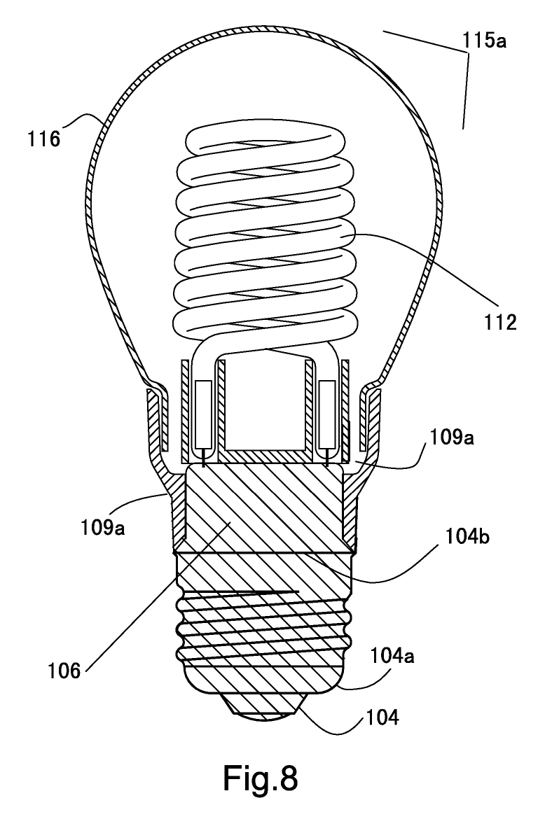

Firstly, for devices with smaller operating power, there is not as much heat from the electronic driver as from the higher power ones. As such, it might not be necessary for the integral ballast assembly to expose at least one portion of its surface directly to air. Referring to FIG. 8, the container connection member 109a of device 115a is attached to integral ballast assembly 106, in such a manner that it bottom is connected to the lamp base 104 along the mouth line 104b of shell 104a.

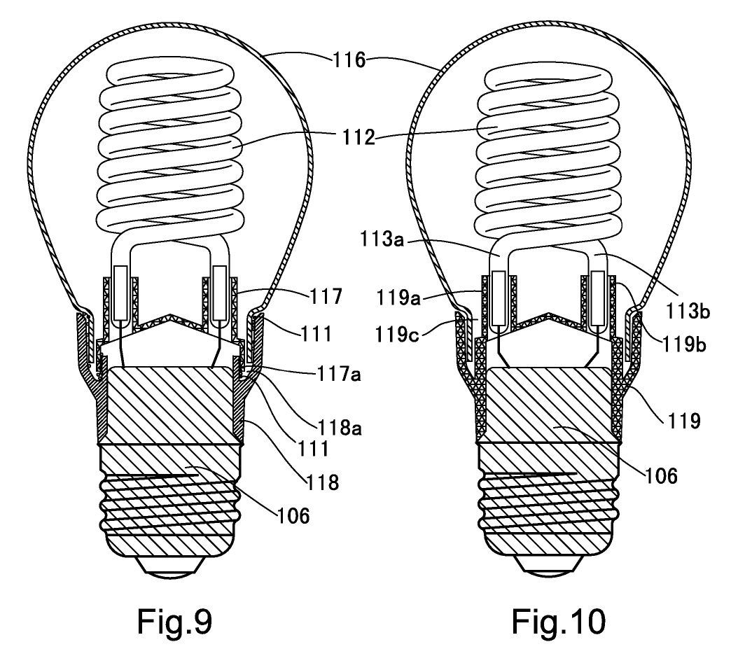

Secondly, the lamp filament support member could be connected to the container connection member, instead of connecting to the integral ballast assembly. Referring to FIG. 9, the lamp filament support member 117 has a cap-like bottom 117a that is attached to the groove 118a of container connection member 118 that is attached to the top of the integral ballast assembly 106. The light-transmitting container 116 is also attached to the opening 118b of the container connection member 118. All these attachments are secured by glue or bonding agent 111 that comprises adhesives such as silicone gel, RTV or other heat-enduring adhesives.

Thirdly, the container connection member and the lamp filament support member may also be combined into a single unit that is attached to the top of the integral ballast assembly, as show in FIG. 10, where the combined lamp filament support and container connection member 119 has two prong-type openings 119a and 119b on its top for adopting the legs 113a and 113b, respectively, of the CCFL filament 112. It also has a circular groove 119c for attaching with the bottom of the light-transmitting container 116. The entire member 119 is then attached to the top of the integral ballast assembly 106 form together with the CCFL filament 112 and the light-transmitting container 116 into a rigid unitary body. In this embodiment, the lamp filament support member (being part of the combined lamp filament support and container connection member 119) is connected to the light-transmitting container 116 in order to support the CCFL filament within the light-transmitting container. This is not the most preferred embodiment of the present invention, but device formed in this manner still enjoy the benefit from the swift heat dissipation feature of the integral ballast assembly provided by the present invention.

### Embodiment 2

In another preferred embodiment of the present invention, both of the lamp filament support member and the container connection member are attached integrally with the integral ballast assembly by using a specially designed mold. Before the heat-conductive compound is filled inside the mold, the lamp filament support member, the container connection member, the electronic driver and the lamp base are all securely disposed inside. At the same time, the electronic driver is coupled to at least two insulated portions of the shell of the lamp base.

In order for the lamp filament support member to be securely placed inside the mold, it is fabricated with at least one leg on the side facing away from the CCFL filament, and said at least one leg has a sufficient length to reach the inner bottom of the shell of the lamp base so that it can fix its position within the mold before the heat-conductive compound is filled inside. Alternatively, the lamp filament support member may have at least one extrusion on the side facing away from the lamp filament, which can allow it to stay securely on top of the electronic driver before the heat-conductive compound is filled inside the mold.

After the heat-conductive compound filled inside the mold is cured or solidified, both the container connection member and that lamp filament support member are attached integrally with integral ballast assembly by the heat-conductive compound filling the space between the electronic driver and the lamp base air-tightly. Using this method, the mold for forming the integral ballast assembly is more complicated, but it eliminates the step of gluing and/or attaching to the lamp filament support member to the integral ballast assembly after the latter is formed.

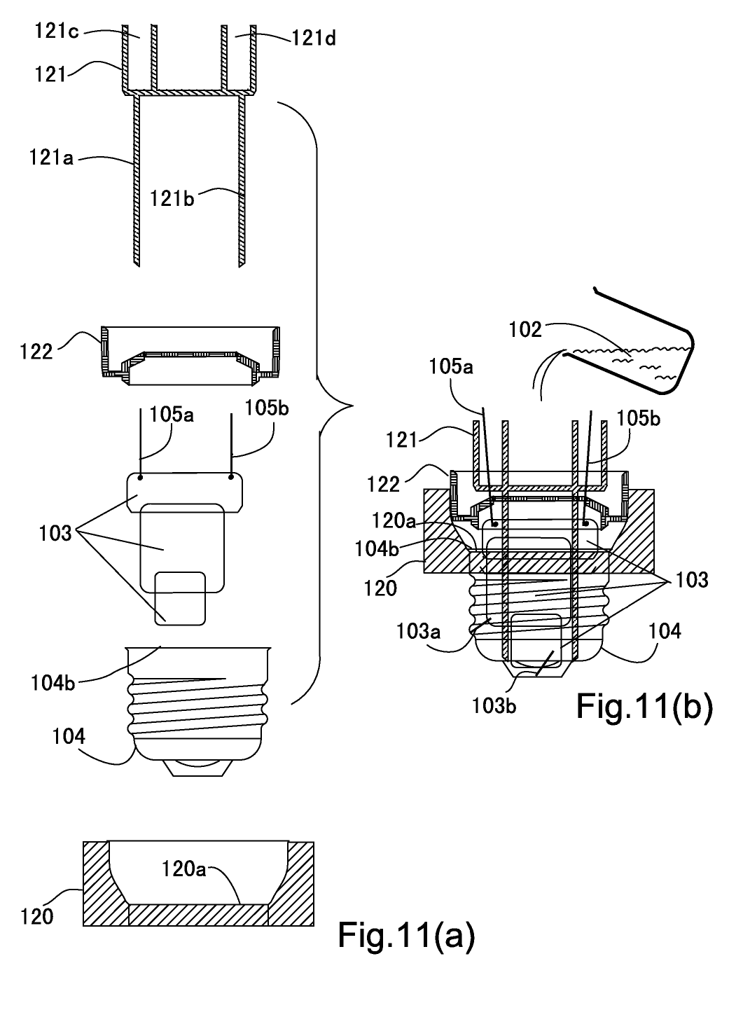

Referring to FIG. 11(a), it shows a water-tight mold 120 that is used for forming an integral ballast assembly integrally combining the lamp filament connection member 121, the container connection member 122, the electronic driver 103 and the lamp base 104.

Referring to FIG. 11(b), it shows the lamp base 104 is inserted into mold 120 and fixes its position relative to mold 120 in such a way that its mouth line 104b meets the upper edge the lower opening 120a of mold 120. Then the various modules of electronic driver 103 are placed inside the mold 120 and lamp base 104, and the driver 103 is also electrically coupled to the lamp base 104 by connectors 103a and 103b. Following that, the container connection member 122 and the legs 121a and 121b of the lamp filament support member 121 are disposed securely inside the mold 120 and the lamp base 104. After the components of the integral ballast are properly placed, the heat-conductive compound 102 is filled inside the mold.

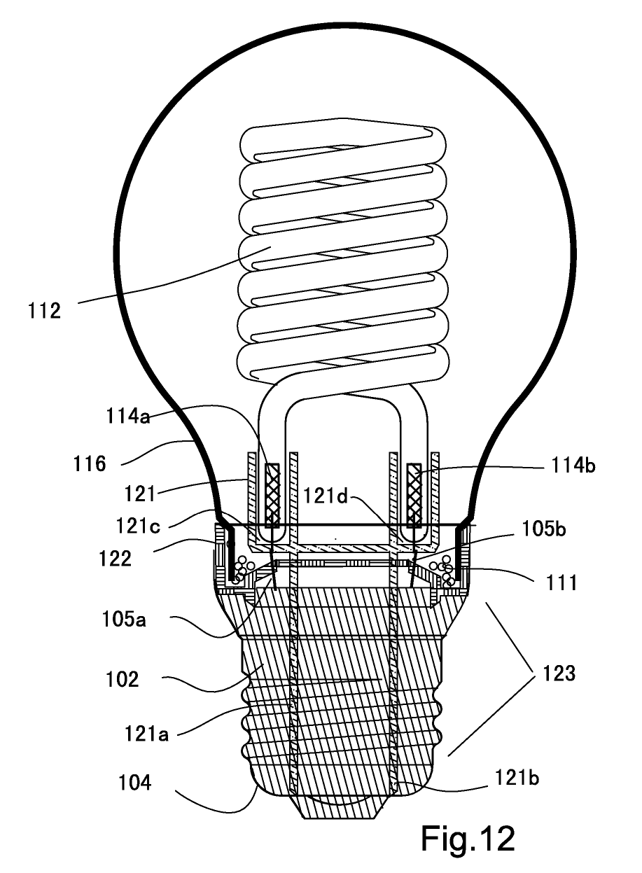

Referring to FIG. 12, it shows a fully assembled CCFL device according to the present invention with CCFL filament 112 attached to and supported by the lamp filament support member 121 that is formed integrally with integral ballast assembly 123, and the light-transmitting container 116 is attached to the container connection member 122 by bonding agent 111 that comprises adhesives such as silicone gel, RTV or other heat-enduring adhesives. The conductors 105a and 105b leading from the cavities 121c and 121d of the lamp filament support member 121 are electrically connected with the electrodes 114a and 114b, respectively, of the CCFL filament 112 attached.

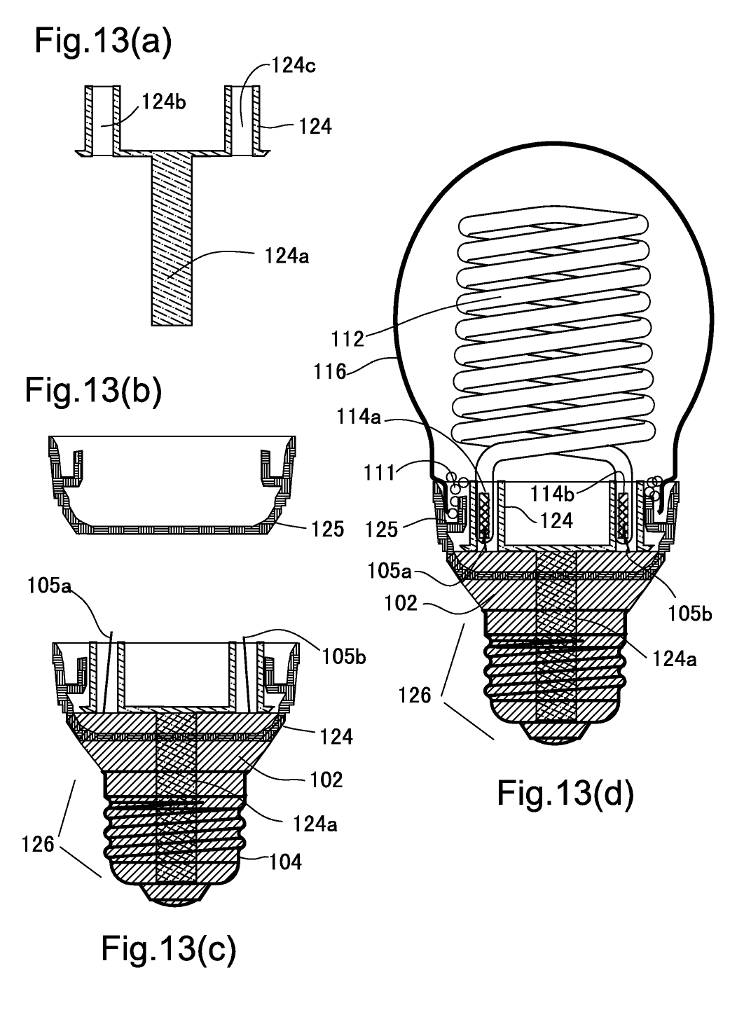

Referring to FIG. 13(a), it shows another lamp filament support member 124 that has a long extrusion 124a on the side facing away from the cavities 124b and 124c for adopting the prong-type legs of a CCFL filament; and referring to FIG. 13(b), it shows anther container connection member 125 that is for a CCFL device of higher power input than that of FIG. 12(b).

Referring to FIG. 13(c), it shows the integral ballast assembly 126 that is formed by a mold (not shown) and is integrally formed together with lamp filament support member 124 and container connection member 125. The lamp filament support member 124 has one long extrusion 124a that is touching the inner bottom of the lamp base 104, and it is further supported by a removable part (not shown) of the mold so that it fixes its upright position within the mold before the heat-conductive compound is filled inside.

Referring to FIG. 13(d), it shows another fully assembled CCFL device according to the present invention that has the CCFL filament 112 attached to and supported by the lamp filament support member 124 that is formed integrally with integral ballast assembly 126, and the light-transmitting container 116 is attached to the container support member 125 by bonding agent 111 that comprises adhesives such as silicone gel, RTV or other heat-enduring adhesives. The connectors 105a and 105b of integral ballast assembly 126 are connected to the lead wires leading from the electrodes 114a and 114b, respectively, of lamp filament 112.

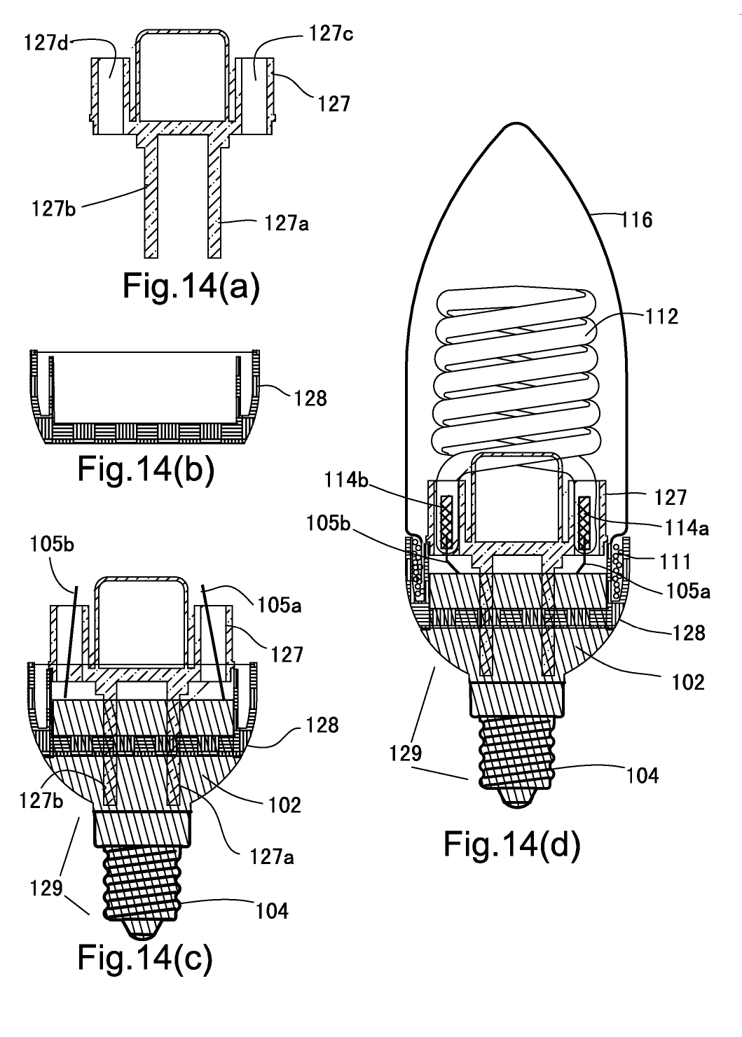

Referring to FIG. 14(a), it shows another lamp filament support member 127 that has a two legs 127a and 127b on the side facing away from the cavities 127c and 127d for adopting the prong-type legs of a CCFL filament; and referring to FIG. 14(b), it shows anther container connection member 128 that is for a CCFL device with a candelabra lamp base.

Referring to FIG. 14(c), it shows the integral ballast assembly 129 that is formed by a mold (not shown), and is integrally formed together with lamp filament support member 127 and container connection member 128. The lamp filament support member 127 has two long legs 127a and 127b that are touching the inner mouth line of the lamp base 104, and it is further supported by a removable part (not shown) of the mold so that it fixes its upright position within the mold before the heat-conductive compound is filled inside.

Referring to FIG. 14(d), it shows another fully assembled CCFL device of a candelabra shaped lamp according to the present invention that has the CCFL filament 112 attached to and supported by the lamp filament support member 127 that is formed integrally with integral ballast assembly 129, and the light-transmitting container 116 is attached to the container support member 128 by bonding agent 111 that comprises silicone adhesive, low melting point soldering glass or other heat-enduring adhesives. The connectors 105a and 105b of integral ballast assembly 129 are connected to the lead wires leading from the electrodes 114a and 114b, respectively, of lamp filament 112.

### Embodiment 3

Another embodiment of the present invention provides for forming a CCFL device which does not have a container connection member and therefore looks almost the same as an ordinary incandescent light bulb, as its entire surface above the month line of the lamp base is the surface of the light-transmitting container. This is achieved by affixing the CCFL filament to a smaller lamp filament support member that is attached integrally with the integral ballast assembly. However, a special mold is used to form a circular cavity around the month line of lamp base, so that bottom of the light-transmitting container can be inserted into this circular cavity and is attached rigidly with the lamp base by using a bonding agent that comprises silicone adhesive, low melting point soldering glass or other heat-enduring adhesives.

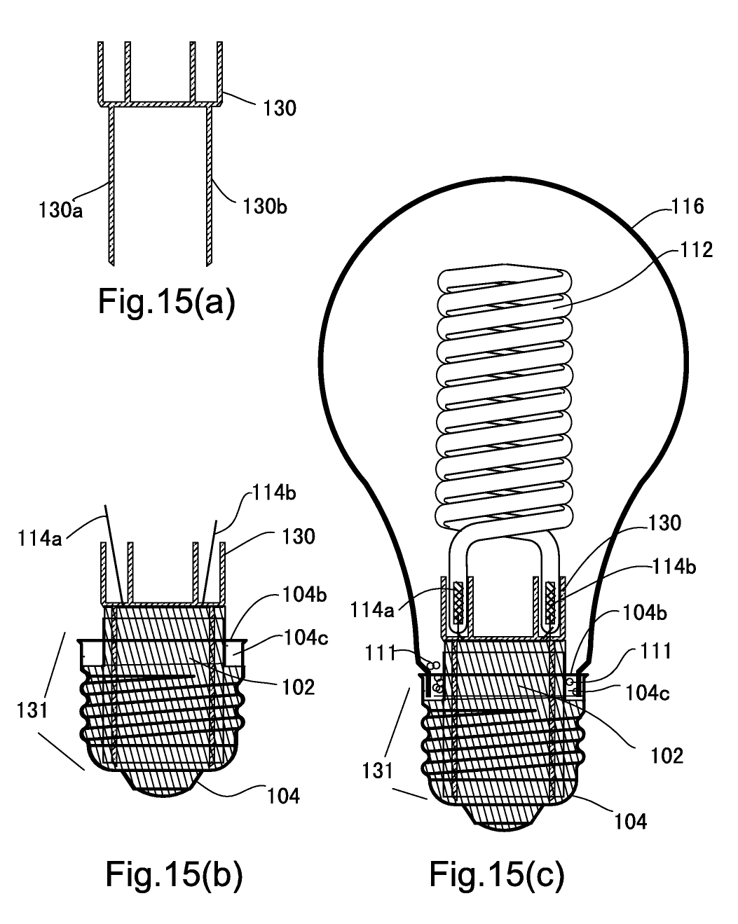

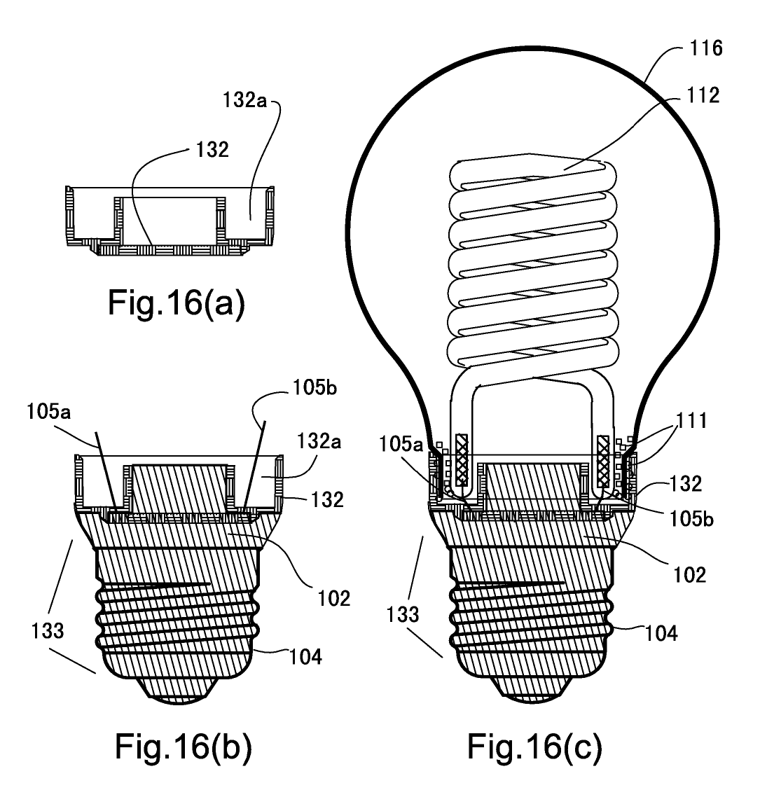

Referring to FIG. 15(a), a small filament support member 130 is fabricated with a plurality of legs 130a and 130b. Referring to FIG. 15(b), integral ballast assembly 131 is formed from the filament support member 130 and the lamp base 104, and the electronic driver (not shown) that is embedded within the heat-conductive compound 102. It is formed by using a two-part mold (not shown) that forms a circular cavity 104c around the mouth line 104b of lamp base 104.

Referring to FIG. 15(c), it is a wholly assembled CCFL device using integral ballast assembly 131, in which the CCFL filament 112 is attached to and supported by lamp filament support member 130 which is integrally attached to integral ballast assembly 131. The bottom of the light-transmitting container 116 is attached directly to the cavity 104c along the month line 104b of lamp base 104 by bonding agent 111 that comprises silicone adhesive, low melting point soldering glass or other heat-enduring adhesives. The connectors 105a and 105b of integral ballast assembly 130 are connected to the lead wires leading from the electrodes 114a and 114b, respectively, of lamp filament 112. There is no container connection member in this embodiment.

### Embodiment 4

Another embodiment of the present invention is similar to the previous two, but no lamp filament support member is used, as the legs of the CCFL filament is bonded directly to the inner surface of the bottom of the light-transmitting container by bonding agent comprising silicone adhesive, low melting point soldering glass or other heat-enduring adhesives. As such, the integral ballast assembly is only formed of a container connection member, the electronic driver and the lamp base.

There are two major benefits from this embodiment. First, the electrodes at the legs of the CCFL filament are bonded closely next to the surface of the light-transmitting container, so the intensive heat generated by the electrodes is dissipated faster to the atmosphere than the case where the CCFL filament is affixed to a lamp filament support member inside the light-transmitting container. Second, as the inner space of the double spiral shaped lamp filament is bigger than those for attachment to a lamp filament support member, this inner space can now house part of the electronic driver. This is useful for the high-power CCFL device, which have two bulky transformers in its electronic driver in order to generate the high-power output electricity.

Referring to FIG. 16(a), it shows a container connection member 132 that has a bigger circular cavity 132a along its top opening, so that both the bottom of the light-transmitting container and the legs of the CCFL filament bonded to the container can be inserted into this cavity. Referring to FIG. 16(b), the integral ballast assembly 133 is formed integrally attached with container connection member 132 by using a mold (not shown).

Referring to FIG. 16(c), it shows a wholly assembled CCFL device using the integral ballast assemblies 133, which is attached by bonding agent 111 to the light-transmitting container 116 that has the legs of the CCFL filament 112 attached to its inner surface at the bottom, also by bonding agent 111. No lamp filament support member is used.

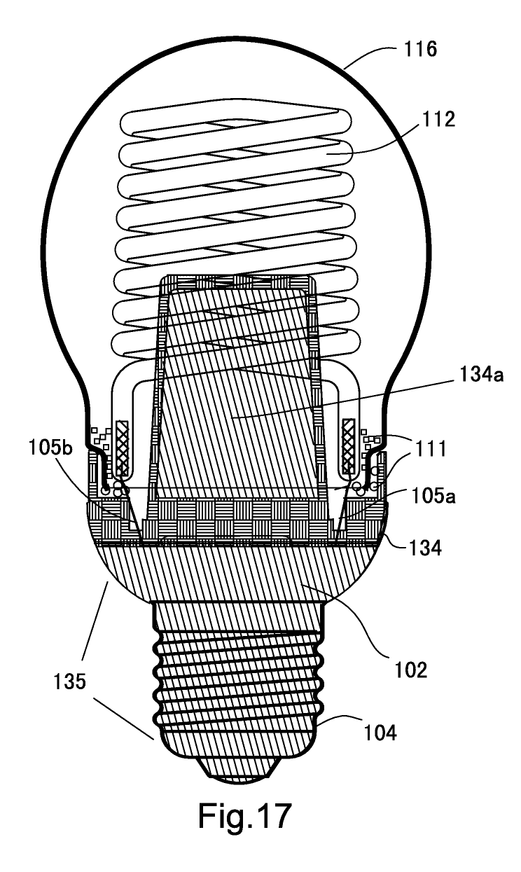

Referring to FIG. 17, the CCFL device has a large container connection member 134 that has a large cap 134a that is extending into the inner space bounded by the double-spiral shaped CCFL filament 112. With such a container connection member 134 forming together with the integral ballast assembly 135, the electronic driver embedded inside can be sufficiently large so that it can operate the CCFL filament 112 at much higher input power.

### Embodiment 5

Another embodiment of the present invention is similar to each of embodiments 2 above, except that, the container connection member is formed from the same heat-conductive compound that is used to form the entire integral ballast assembly, using specially designed two-part mold that has an internal shape similar to integral ballast assembly formed according to embodiment 2 in the above. As such, there is no need to fabricate a separate container connection member using other materials. The integral ballast assembly formed in this manner has its own container connection cavity for attaching to the bottom of the light-transmitting container by bonding agent such as silicone adhesive, low melting point soldering glass or other heat-enduring adhesives.

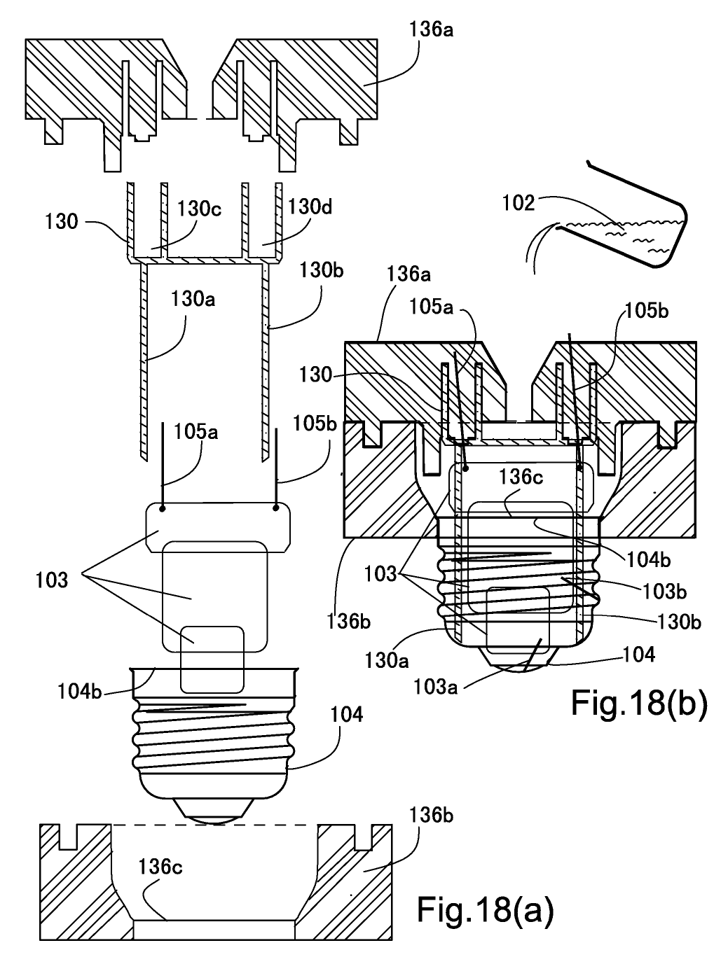

Referring to FIG. 18(a), it shows two-part mold 136 with an upper-part mold 136a and a lower-part mold 136b that are used for forming an integral ballast assembly integrally combining the lamp filament connection member 130, the electronic driver 103 and the lamp base 104.

Referring to FIG. 18(b), it shows the lamp base 104 is inserted into lower-part mold 136b and fixes its position relative to mold 136b in such a way that its mouth line 104b meets the upper edge the lower opening 136c of lower-part mold 136b. Then the various modules of electronic driver 103 are placed inside the lower-part mold 136b and lamp base 104, and the electronic driver 103 is also electrically coupled to the lamp base 104 by connectors 103a and 103b. Following that, the legs 130a and 130b of the lamp filament support member 130 are disposed securely inside the lower-part mold 136b and the lamp base 104. After the components of the integral ballast are properly placed, the upper-part mold 136a is put on top of the lower-part mold 136b, with it cavities embracing the wall of the cavities 130c and 130d of lamp filament support member 130. Finally, the heat-conductive compound 102 is filled inside the mold from the opening of the upper-part mold 136a.

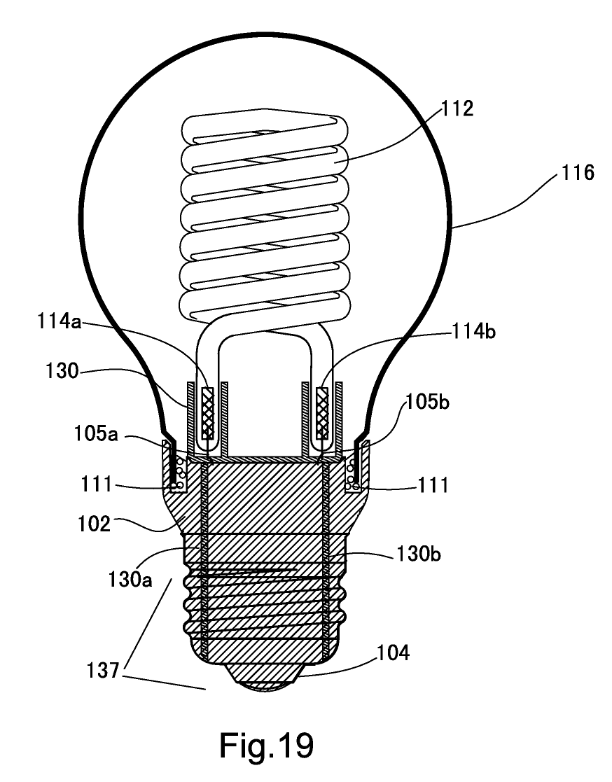

Referring to FIG. 19, it shows a fully assembled CCFL device according to the present invention with CCFL filament 112 attached to and supported by the lamp filament support member 130 that is formed integrally with integral ballast assembly 137 formed by the mold 136 of FIG. 18(b), and the light-transmitting container 116 is attached to the container connection opening of integral ballast assembly 137 by bonding agent 111 that comprises adhesives such as silicone gel, RTV or other heat-enduring adhesives. The conductors 105a and 105b leading from the cavities 130c and 130d of the lamp filament support member 130 are electrically connected with the electrodes 114a and 114b, respectively, of the CCFL filament 112 attached.

### Embodiment 6

Another embodiment of the present invention is similar to each of embodiments 2 and 5 above, except that, both the container connection member and the lamp filament support member are formed from the same heat-conductive compound that is used to form the entire integral ballast assembly, using a specially designed two-part mold. As such, there is no need to fabricate the container connection member and the lamp filament support member separately from other materials. The integral ballast assembly formed in this manner has its own container connection cavity for attaching to the bottom of the light-transmitting container by bonding agent such as silicone adhesive, low melting point soldering glass or other heat-enduring adhesives. It also has its own lamp filament support cavities for adopting mechanically the legs of the CCFL filament in order to support the CCFL filament.

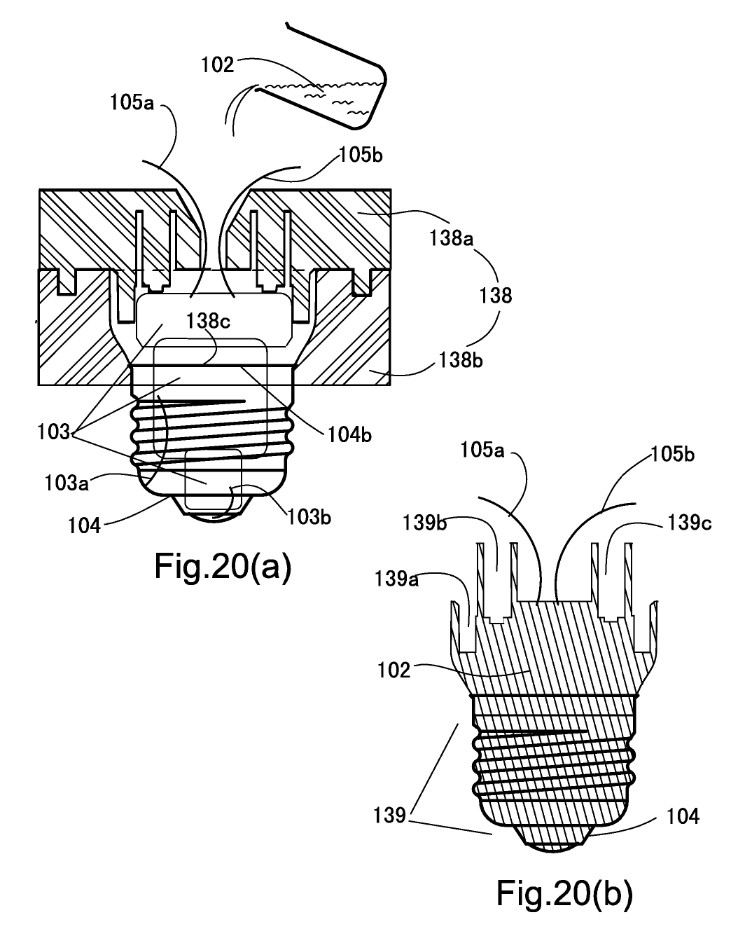

Referring to FIG. 20(a), it shows two-part mold 138 with an upper-part mold 138a and a lower-part mold 138b that are used for forming an integral ballast assembly integrally combining the electronic driver 103 and the lamp base 104. Within the mold 138, it shows the lamp base 104 is inserted into lower-part mold 138b and fixes its position relative to mold 138b in such a way that its mouth line 104b meets the upper edge the lower opening 138c of lower-part mold 138b. Then the various modules of electronic driver 103 are placed inside the lower part mold 138b and lamp base 104, and the electronic driver 103 is also electrically coupled to the lamp base 104 by connectors 103a and 103b. Following that, the upper part mold 138a is put on top of the lower part mold 138b, and the heat-conductive compound 102 is filled inside the mold 138 from the opening of the upper-part mold 138a.

Referring to FIG. 20(b), it shows the integral ballast assembly 139 after detached from the mold 138 (not shown). It has its own circular container connection cavity 139a and two lamp filament support cavities 139b and 139c respectively.

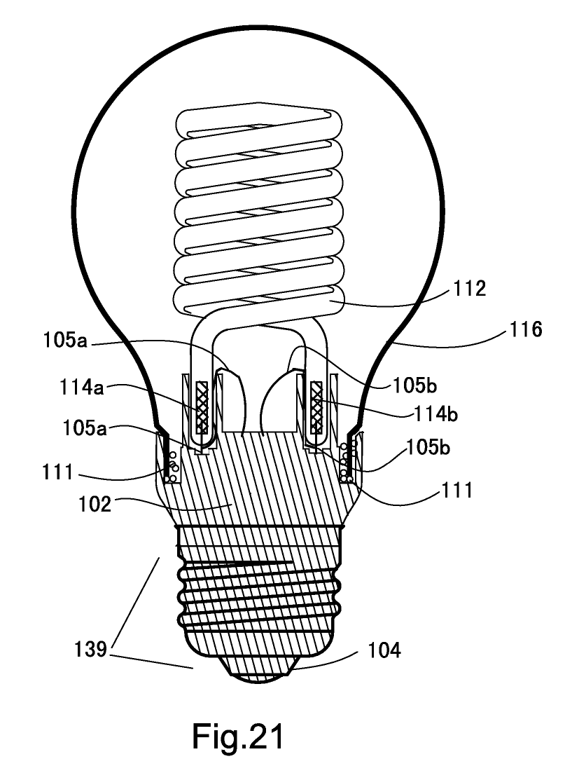

Referring to FIG. 21, it shows a fully assembled CCFL device according to the present invention using the integral ballast assembly 139 that is formed by mold 138 (not shown) of FIG. 20(a). The light-transmitting container 116 is attached to the container connection cavity 139a of integral ballast assembly 139 by bonding agent 111 that comprises adhesives such as silicone gel, RTV or other heat-enduring adhesives. Similarly, the legs of CCFL filament 112 are attached to the lamp filament support cavities 139b and 139c of the integral ballast assembly 139 by bonding agent 111. The conductors 105a and 105b leading from top of integral ballast assembly 139 are passing down from the top of the cavities 139b and 139c, respectively, and are electrically connected to the electrodes 114a and 114b of the CCFL filament 112 attached.

### Embodiment 7

Another embodiment of the present invention is similar to each of embodiments 1, 2, 3, 4 and 5 and 6 above, except that the CCFL devices are hermetically sealed with a high thermal conductivity gas inside. This is accomplished by sealing the a container connection member with the bottom of the light-transmitting container hermetically by using low melting point soldering glass or vacuum adhesives. As the other opening of the container connection member is either sealed hermetically by using low melting point soldering glass or vacuum adhesives to the attached surface of the integral ballast assembly, or is formed integrally with the integral ballast assembly, the entire internal space bounded by the inner surfaces of the light-transmitting container, the internal surface of both the container connection member (if any), and the integral ballast assembly, form a hermetically sealed space for storing the high thermal conductivity gas.

This embodiment therefore provides for a novel hermetical sealing method that does not require sealing the bottom of the light-transmitting container by using a lamp foot or a base plate. Nevertheless, in order to evacuate air and fill in the heat-conductive gas medium at the final stage of lamp assembly, a small exhaust tube is embedded inside the integral ballast assembly before epoxy/resin is filled in when the integral ballast assembly is formed. This exhaust tube has one end opens to the filament connection side of the integral ballast assembly, and the other end opens at a side position immediately above the mouth line of the lamp base. In order for the hermetical seal to be lasting, the small exhaust tube is preferably made of heat contractible plastic so that when sealed by flame after the high-conductivity gas is filled it, it contracts into the inside of the integral ballast assembly, and the small hole left at the original opening of the exhaust tube on the surface of the integral ballast assembly is sealed by epoxy or other vacuum adhesives.

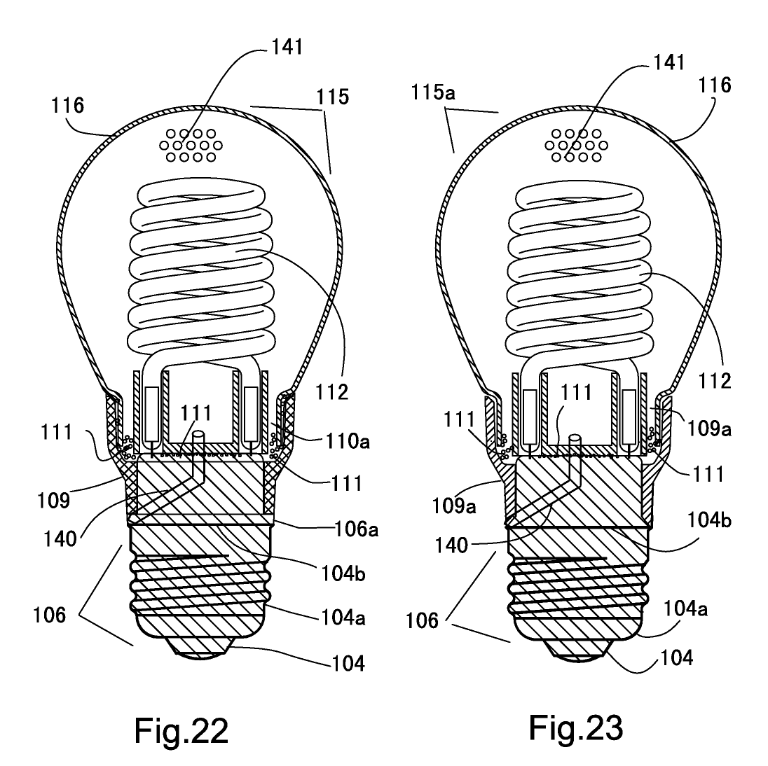

Referring to FIG. 22, it shows a wholly assembled CCFL devices almost same as the one of FIG. 7(c) that uses the integral ballast assembly 106, and differs only in that it has an exhaust tube 140 the communicates from the outer surface of the integral ballast assembly 106 above the mouth line of the lamp base 104, to the hermetically sealed inner space that is bonded by the inner surfaces of the light-transmitting container 116, the container connection member 109 and top inner surface of integral ballast assembly 106. Air is evacuated from the exhaust tube 140, and a high thermal conductivity gas 141 is filled inside before the end of the exhaust tube 140 on the outer surface of the integral ballast assembly is hermetically sealed.

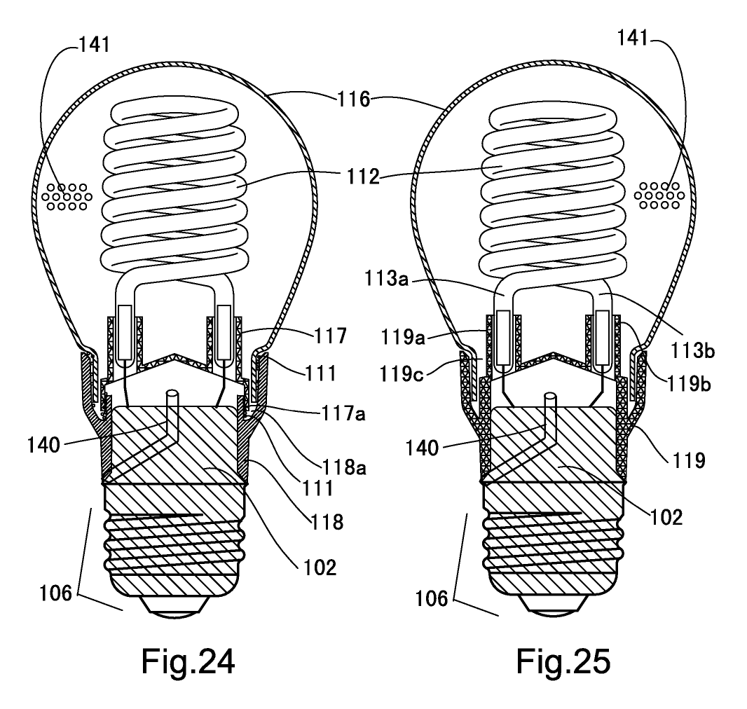

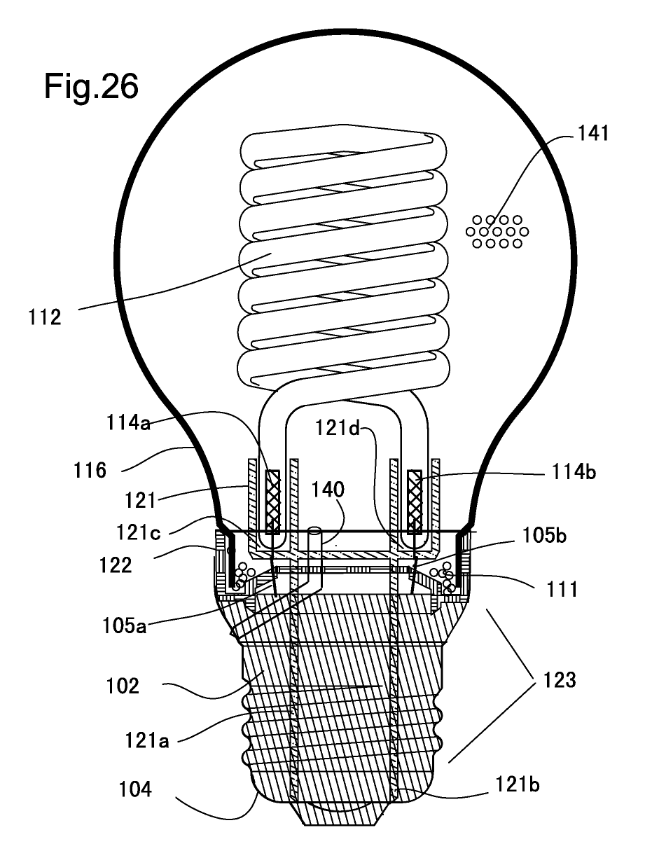

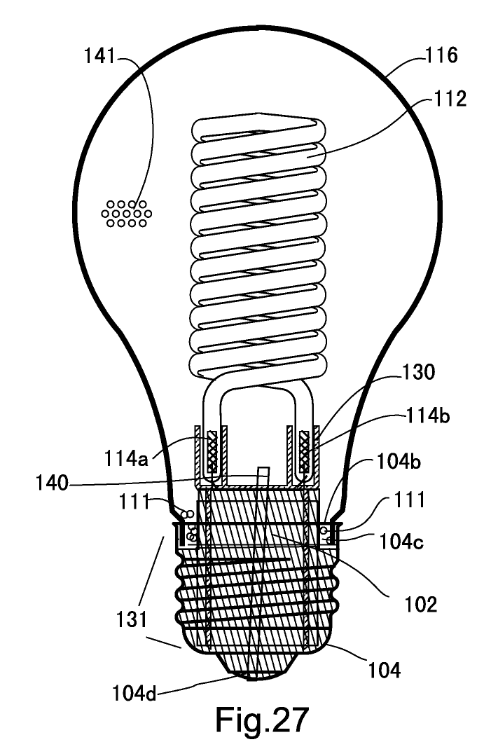

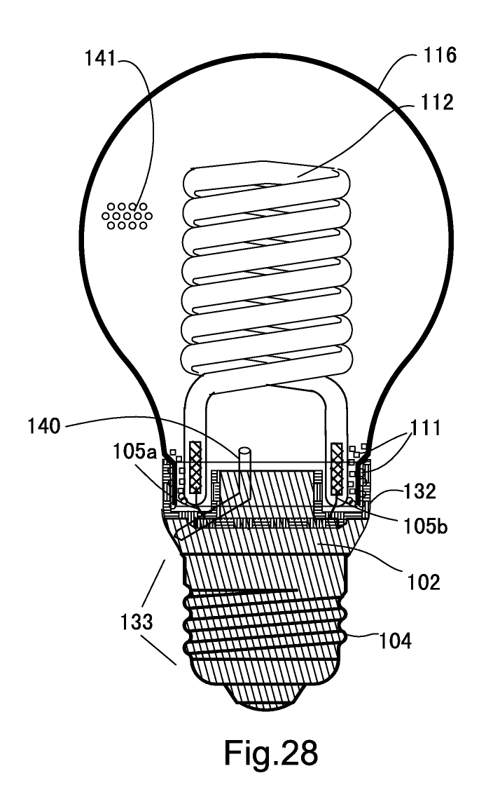

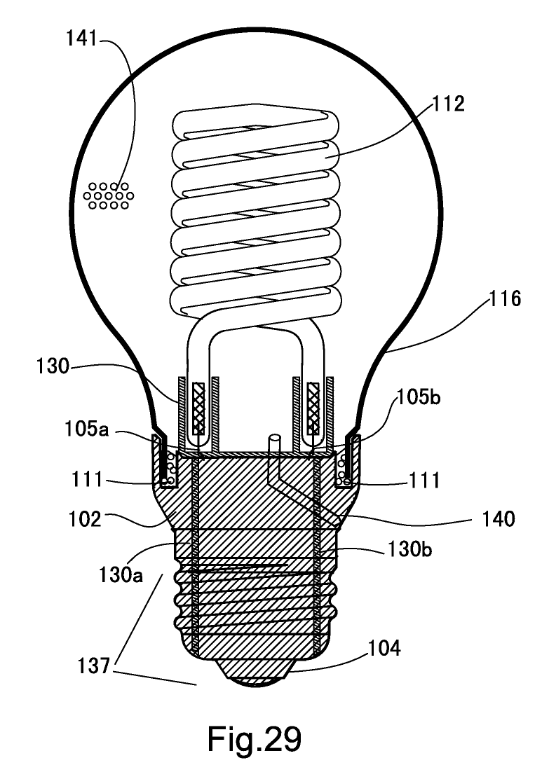

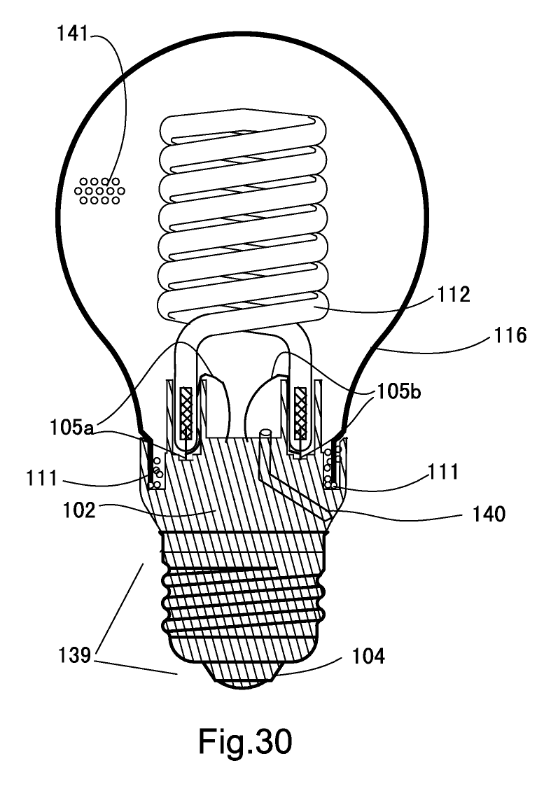

Referring to FIG. 23 to FIG. 30, these are eight wholly assembled CCFL devices that are the same as the ones of FIG. 8, FIG. 9, FIG. 10, FIG. 12, FIG. 15(c), FIG. 16(c), FIG. 19 and FIG. 21, respectively, except that, apart from the device of FIG. 27, they all differ from their respective counterparts in that each of them has an exhaust tube 140 the communicates from the outer surface of its integral ballast assembly above the mouth line of the lamp base 104, to the hermetically sealed inner space that is bonded by the inner surfaces of the light-transmitting container 116, the container connection member (if any) and top inner surface of its integral ballast assembly. Air is evacuated from the exhaust tube 140, and the high thermal conductivity gas 141 is filled inside before the end of the exhaust tube 140 on the outer surface of the integral ballast assembly is hermetically sealed.

Referring to FIG. 27, the CCFL device here does not have a container connection member as the bottom of the light-transmitting container 116 is attached to the mouth of the lamp base 104. As such, the other end of the exhaust tube 140 passes out from the end 104d of lamp base 104 where there is always a hole for one electrical conductor (not shown) coupling the electronic driver and the lamp base to pass through before it is soldered to a contact of the end 104d. This end of the exhaust tube 140 is sealed off after air is evacuated from the inner space bonded by the inner surfaces of the light-transmitting container 116 and the upper surfaces of integral ballast assembly 131, and after a high thermal conductivity gas is injected inside said inner space. After the end of exhaust tube 140 is sealed off, the electrical conductor (not shown) leading from the electronic driver is soldered to a contact at end 104d.

### Embodiment 8

In another preferred embodiment, the light-transmitting container of the CCFL device is doubled walled, and the CCFL lamp filament is sandwiched in the space between the two walls, and a heat-conductive medium is filled in between the walls which is hermetically sealed at their bottoms in case the heat-conductive medium is a high thermal conductivity gas, but said walls are not hermetically sealed if the heat-conductive medium is a solid light-transmitting compound, such as soft epoxy, acrylic, or other resins. Such a double-walled light-transmitting container is normally of cylindrical or cone shapes.

As the CCFL filament is now placed only at a short distance from the outer shell and with either the high thermal conductivity gas or the solid light-transmitting compound serving as a thermal bridge, heat generated from the CCFL filament is dissipated into the atmosphere swiftly. As such, CCFL device of this kind can operate at a much higher electricity power input or 16-18 watts or more, even the size of the outer shell is still similar to that of an ordinary incandescent light bulb. Moreover, it provides an added advantage that a reflective layer may be coated onto any one side of the inner shell to reflect light to the outer container surface, so that the CCFL device generates more visible light.

Moreover, with the solid light-transmitting compound embedding the CCFL filament and attaching it to the surface of the light-transmitting container, it is no longer necessary to use a lamp filament support to fix the position of the lamp filament within the device, thereby simplifies the assembly process significantly.

Finally, as the inner space enclosed by the CCFL filament is much larger than those CCFL devices with an A-shaped lamp body, it can house a bigger electronic driver that can produce more operating power for the CCFL.

For the device of this embodiment which uses a hardened solid light-transmitting compound to form integrally with the CCFL filament, the CCFL filament should preferably be coated with a soft light-transmitting compound substantially along its length, so that the different coefficients of expansion of the solid light-transmitting compound and the glass envelope of the CCFL filament will not create excessive pressure on the CCFL filament embedded inside. As such, there are at least one, and preferably two layers of solid light-transmitting compound embedding the CCFL filament substantially along its length. The hardened outer layer is in thermal contact of the inner softer layer(s) that is(are) in direct thermal contact with the CCFL filament.

In the entire specification of the present invention, in case a solid light-transmitting compound is used, it always refers to the arrangement explained herein that the solid-transmitting compound is multi-layered with each different layers having a different coefficient of heat expansion, and the inner layer(s) is(are) soft enough to absorb the pressure on the embedded CCFL filament that is created by the different coefficient of expansion of the CCFL filament and the outer layer of hardened solid light-transmitting compound, and/or the light-transmitting container that is housing the solid light-transmitting compound and the CCFL filament inside.

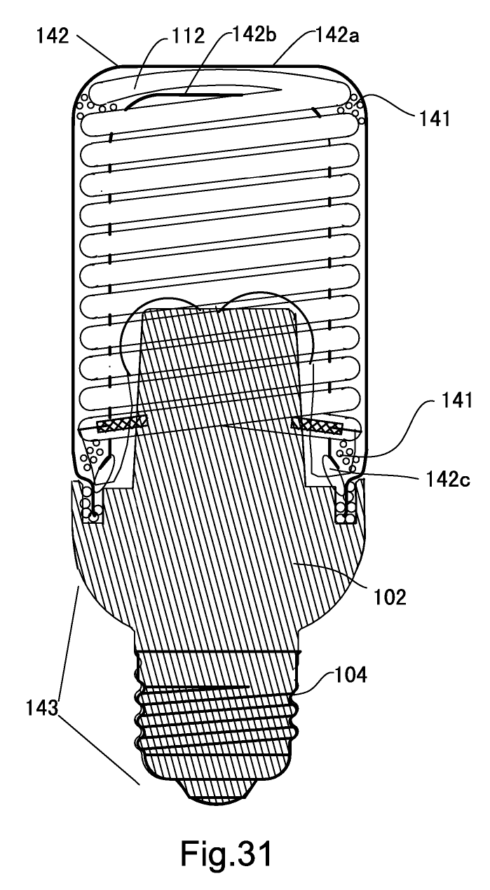

Referring to FIG. 31, the CCFL device has a cylindrical shaped lamp body which has a double-walled container 142 filled with a high thermal conductivity gas 141 filled between its outer container wall 142a and inner container wall 142b, which are hermetically sealed at their bottom 142c. The CCFL filament 112 is also located at the space between the container walls 142a and 142b. It is a high input power CCFL device, with a large electronic driver (not shown) that is embedded inside its integral ballast assembly 143.

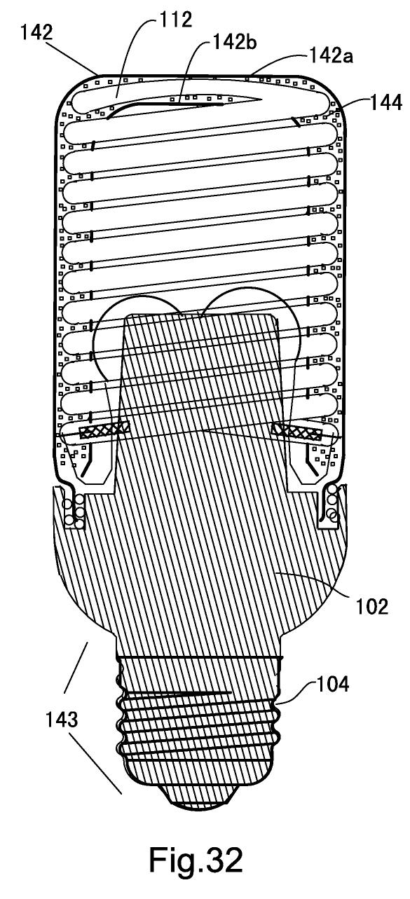

Referring to FIG. 32, the CCFL device has the same lamp body and same integral ballast assembly 143 as that of FIG. 31, but a solid light-transmitting compound 144 such as soft epoxy, acrylic, or other resins, is placed between the two container wall 142a and 142b. No hermetical seal is formed at the bottom of the two walls 142a and 142b. The solid light-transmitting compound 144 may have at least one layer, and the layer that is directly in thermal contact with CCFL filament 112 is a soft solid layer that can absorb the pressure created on the CCFL filament 112 due to the different coefficients of expansion of the glass envelop of the CCFL filament 112 and the of the light-transmitting container walls 142a and 142b.

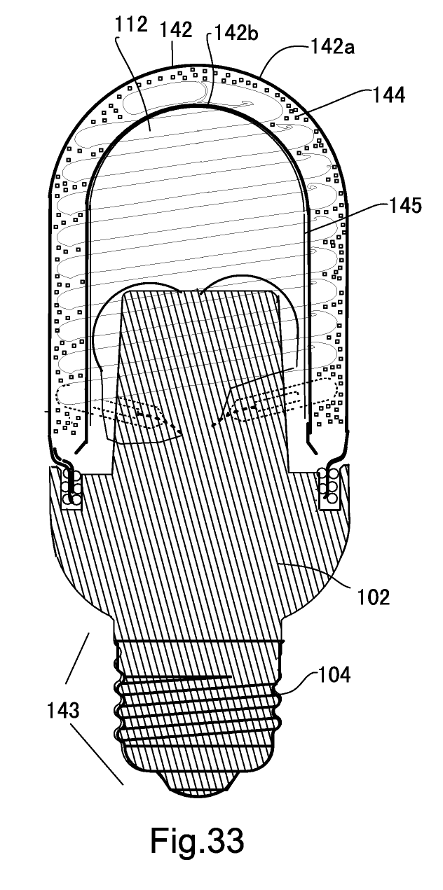

Referring to FIG. 33, the CCFL device is similar to that of FIG. 32, as it also has a solid light-transmitting compound 144 placed between the two container shells 142a and 142b. However, its light-transmitting container 142 is cone shaped, and there is also a reflective layer 145 formed at the inner surface of the shell 142b, so that the device can transmit more light through the outer container wall 142a.

In another preferred embodiment, a solid light-transmitting compound, such as soft epoxy, acrylic, or other resins, is filled inside the entire space of the light-transmitting container. This eliminates the need for evacuating air from and filling the high thermal conductivity gas, and there is also no need to form the hermetical seals at the bottom of the light-transmitting containers. The solid light-transmitting compound generally has better thermal conductivity than all of the high thermal conductivity gases, including the helium gas and the hydrogen gas.

Moreover, the mechanical strength of the CCFL filament becomes significantly enhanced that it can withstand strong mechanical and vibration shocks. It also becomes much easier and less costly to add color and diffuser to the device, as different color pigments and diffusing powders can be added to the solid light-transmitting compound before it is used to embed the CCFL filament. However, the solid light-transmitting compound is much heavier. For this reason, it is only preferable for the tubular shape light-transmitting containers that have lesser interior cavities.

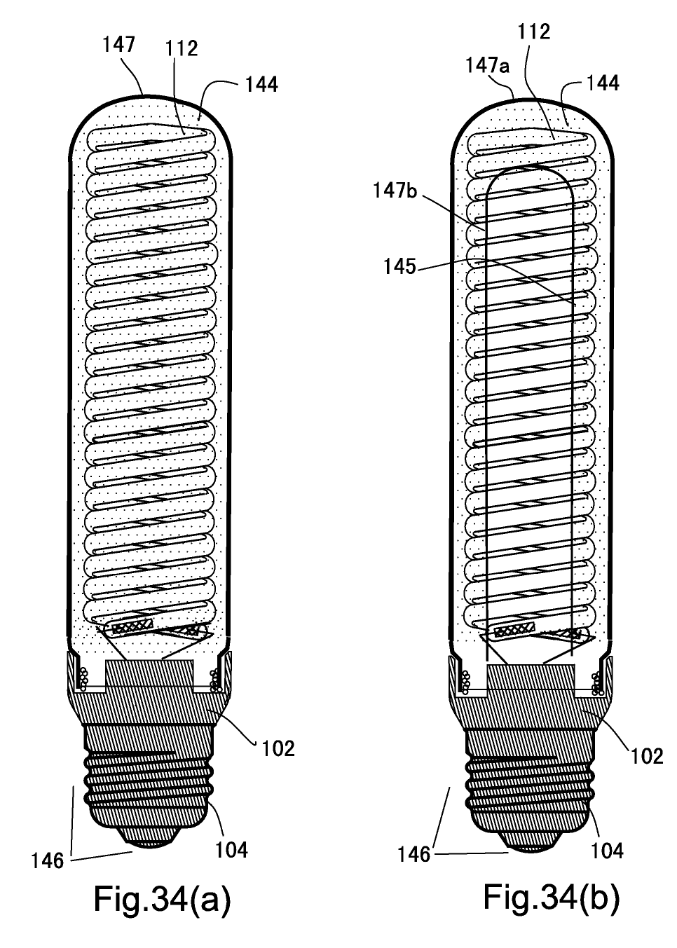

Referring to FIG. 34(a), the CCFL device with a tubular lamp body housing a double spiral CCFL filament 112, and it is attached to integral ballast assembly 146. A solid light-transmitting compound 144 is filled entirely inside the tubular light-transmitting housing 147. Such a CCFL device is best for replacement of the 1U- or 2U-HCFL lamps, as it has a similar form factor with the latter, but provides more light and is of longer life, apart from being able to be dimmed by an ordinary wall dimmer.

Referring to FIG. 34(b), the CCFL device differs from that of FIG. 34(a) only in that it has inner shell 147b in addition to the outer shell 147a, and a reflective layer 145 is coated on the inner surface of 147b. The reflective inner shell 147b provides more light to pass out from the outer shell 147a, and also allows lesser solid light-transmitting compound 144 to be used, as it is empty inside.

### Embodiment 9

In another preferred embodiment, the same solid light-transmitting compound is used to embed the entire CCFL filament as in the embodiment immediately above, but the CCFL device instead of having a glass container, is coverless, as the surface of the solid light-transmitting compound forms the entire surface of the device apart from the portion that is the integral ballast assembly. A mold with internal shape same as a light-transmitting container of a pre-determine shape is used to from coverless lamp body of the device. In doing so, the lamp body may also be seamlessly integrated with the integral ballast assembly, so that no bonding agent is need to attach them together.

The above method also eliminates the need for evacuating air from and filling the high thermal conductivity gas, and there is also no need to form the hermetical seals at the bottom of the light-transmitting containers. The heat generated by the CCFL filament can now be conducted much faster away from the CCFL filament, as the glass cover is omitted. In addition, the mechanical strength of the CCFL filament becomes significantly enhanced so that it can withstand strong mechanical and vibration shocks. This embodiment, however, due to weight of the solid heat-conductive medium, is only preferred for lamp bodies of a cylindrical or conical shape.

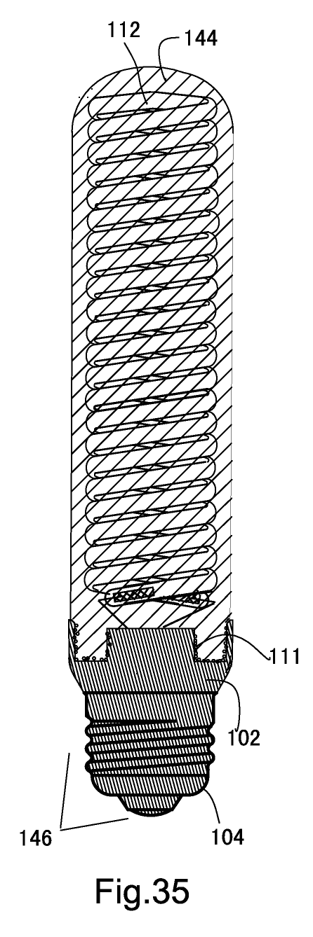

Referring to FIG. 35, the CCFL device with a tubular lamp body that is formed entirely from the solid light-transmitting compound 144 by using a mold (not shown) with internal shape same light-transmitting container 147 of the CCFL device of FIG. 34(a). Its lamp body is attached to the integral ballast assembly 146 by bonding agent 111.

In another preferred embodiment, the CCFL filament is covered on its outer surface with a transparent shatter-resistant silicone coating. There are many commercially available shatter-resistant coating materials that serve the requirement of the present invention satisfactorily, such as the fluoropolymer material of the Teflon family products like PTFE and FEP. The protective coating, apart from providing enhanced mechanical strength to the CCFL filament, will also contain the glass fragments in case the filament is broken. With such a thin coating, normally of less than 0.5 mm, the heat generated by the lamp filament can swiftly be dissipated into the atmosphere, particularly when the coating is punched with multiple tiny holes to allow the hot air trapped inside the spiral filament to be released outside. With such a coating, it may not be necessary to enclose the CCFL filament within a light-transmitting container.

### Embodiment 10

In still another preferred embodiment, the use of CCFL filaments embedded inside a solid light-transmitting compound as described above is extended to those plug-in lamps and tubular lamps that do not have full electronic driver integrated with the devices. These CCFL plug-in lamps of the present invention are alternatives to the ordinary HCFL plug-in lamps of 1U, 2U, 4U, 6U, and etc. shapes which use the G23, G24 or G24d bi-pin or quad-pin electrical connectors as lamp bases. Similarly, the CCFL tubular lamps of the present invention that have the CCFL filaments embedded inside a solid light-transmitting compound, are better alternatives for the HCFL T5, T8, T9 and T12 fluorescent lamps, which use G5, G13 or R17d bi-pin electrical connectors.

There are wide applications of the HCFL plug-in lamps with G23 G24 or G24d electrical connectors, and of the HCFL T5, T8, T9 and T12 lamps with G5, G13 or R17d bi-pin electrical connectors, particularly in positions such as ceilings and lamp posts that are difficult to reach. The short life span of the HCFL is therefore causing significant difficulties owing to the frequent replacement needs, as well as the high positions that are difficult to reach. Moreover, these HCFL devices are not dimmable by ordinary wall dimmers. As such, it is highly desirable to have long-life and dimmable alternatives for them provided for by the CCFL type of T5, T8, T9 and T12 lamps and the CCFL type of plug-in lamps using G23 G24 or G24d electrical connectors, which can operate at high electricity power input.

The long-life and dimmable CCFL alternatives, according to the present invention, for the ordinary HCFL plug-in lamps commonly known as the PLs (brand name of Philips), Biax (brand name of GE) and Dulux (brand name of Osram), have at least one CCFL filament coiled into spiral or multi-U shape, housing inside a tubular light-transmitting container attaching with the G23, G24 or G24d electrical connectors. As these alternative CCFL plug-in lamps are aiming for high electricity power input, their light-transmitting containers are filled with a solid light-transmitting compound such as soft epoxy, acrylic, or other resins, so that heat can be conducted swiftly through the compound to the surface of the container. With the solid light-transmitting compound in place, these CCFL devices may also omit the light-transmitting container, as the hardened outer surface of the solid light-transmitting compound can be exposed directly to air.

For the plug-in lamps, their electrical connectors are always big enough to house part of the electronic driver. As such, the high-voltage transformer, being the output component of the full electronic driver, can be placed inside the electrical connector, together with a fuse and other components necessary for the high-voltage transformer to generate high-voltage electricity after receiving the low voltage high-frequency electricity from the remaining part of the full electronic driver that is located externally. In this way, the low voltage electricity can pass safely through a longer distance between the partial driver and the electrical connector of the CCFL device.

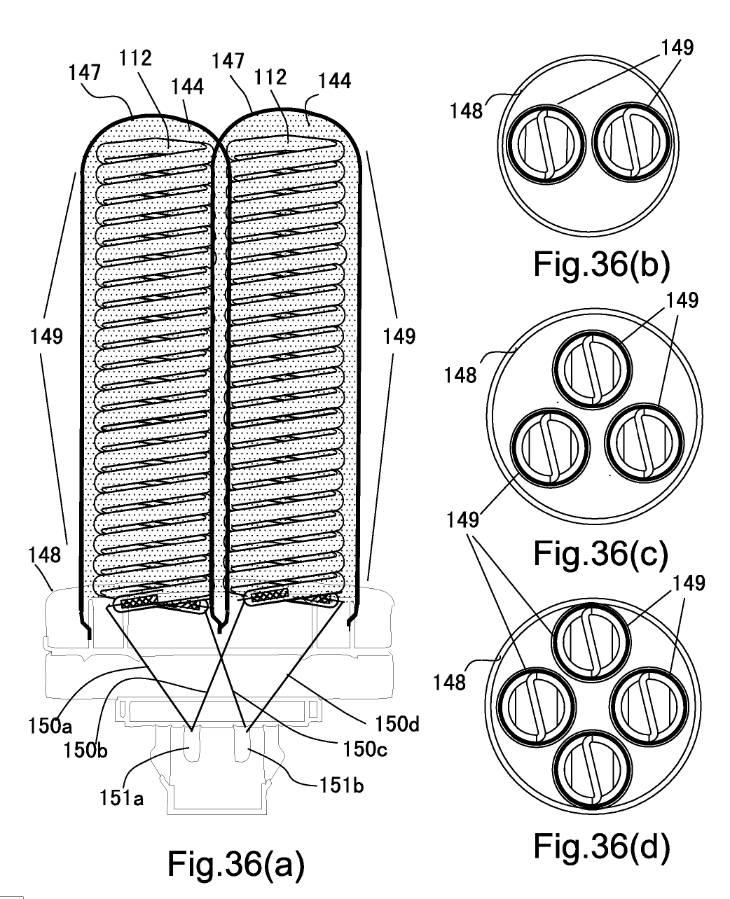

Referring to FIG. 36(a), a plug-in lamp with a 4-pin G24/G24d-type electrical connector 148 attached to two tubular lamp bodies 149, each of which has a double spiral CCFL filament 112 inside being embedded in a solid light-transmitting compound 144, and there is no need for the light-transmitting container 147 to hermetically sealed. The conducting wires 150a, 150b, 150c and 150d are connected to two pins 151a and 151b of the 4-pin electrical connector 148 which can be any of the G23, G24 and G24d electrical connector types or alike.

Referring to FIG. 36(b), FIG. 36(c) and FIG. 36(d), theses are cross-sectional views from the top for CCFL device similar to that of FIG. 36(a), that has 2, 3 and 4 tubular lamp bodies 149 attached to the electrical connector 148, respectively.

As an alternative to the CCFL devices of FIG. 36(a) to FIG. 36(d), the light-transmitting container 147 may be omitted and the hardened outer surface of the solid light-transmitting compound 144 is exposed directly to air, so that the device can have better heat dissipation ability than those with light-transmitting container 147.

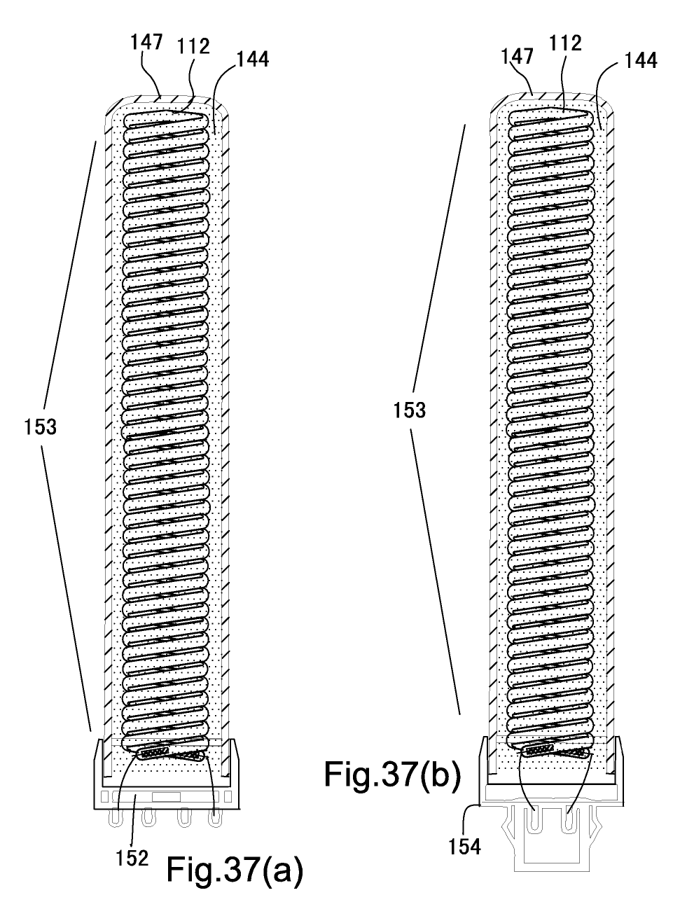

Referring to FIG. 37(a), a plug-in lamp with a 4-pin electrical connector 152 attached to tubular lamp body 153, has a double spiral CCFL filament 112 inside being embedded in a solid light-transmitting compound 144 filled inside the light-transmitting container 147.

Referring to FIG. 37(b), another plug-in lamp with another 4-pin electrical connector 154 attached to tubular lamp body 153, is also having a double spiral CCFL filament inside being embedded in a solid light-transmitting compound 144 filled inside the light-transmitting container 147.

As an alternative to the CCFL devices of FIG. 37(a) and FIG. 37(b), the light-transmitting container 147 may be omitted, and the hardened outer surface of the solid light-transmitting compound 144 is exposed directly to air, so that the device can have better heat dissipation ability than those with light-transmitting container 147.

On the other hand, the long-life and dimmable CCFL alternatives according to the present invention for the ordinary HCFL fluorescent tubular lamps of T5, T8, and T12 shape that use G5 or G13 bi-pin lamp bases, contains at least one elongated CCFL filament that is bent into to 1-U, 2-U, 3U or multi-U shaped linear forms, housing inside the light-transmitting containers of T5, T8, T9 or T12 shapes that is filled with a solid light-transmitting compound such as soft epoxy, acrylic, or other resins. The at least one elongated CCFL filament can also be a linear one without any U or other bending.

As the tubular CCFL devices above use external electronic drivers that are detached from the device by a considerable length, and it is undesirable to transfer high-voltage electricity of 500-2,500 volts over such long distance. As such, it would be most desirable to have the electronic driver as close to their electrodes as possible. For these CCFL tubular lamps, they always have a large fixture holding the lamp as well as for housing the electronic driver. Conventional CCFL tubular design uses the same format of the HCFL that electricity are supplied from both ends of the tubular filament, but this should be avoided, as it is dangerous to transfer high-voltage electricity of 500-2,500 volts over long distances within the fixture.

Fortunately, each electrical connector of such tubular devices have two bi-pin electrical connectors, which are either the standard G5 or the standard G13 electrical connectors that are attached to both ends of the tubular device. As such, the electrodes can be electrically coupled in such a way the only one bi-pin connector at one end is used for electricity connection, leaving the other one have neither of its two pins electrically coupled to the electrodes of the CCFL filament, and is only used for attaching to the electrical sockets for supporting the lamp mechanically. In this manner, according to the present invention, the electrical connections for the electrodes to the pins for the electrical connectors of the CCFL T5, T8, T9 or T12 tubular lamps with G5, G13 or R17d connectors can be carefully designed so that the external electronic driver is positioned close to only one end of the tubular CCFL devices and supplies electricity to the device through both pins of only one selected 2-pin electrical connector.

For the sake of providing the novel CCFL device of the present invention for those preferring conventional style of connecting tubular lamps by placing the ballast mid-way between both ends of the tubular device, the CCFL T5, T8, T9 or T12 tubular lamp of this invention that are having a plurality of G5, G13, or R17d bi-pin electrical connector, and a solid light-transmitting compound filled inside the light-transmitting container, may also have their electrodes so connected that external electricity is supplied to one or both pins on each bi-pin electrical connectors at both ends of the tubular device.

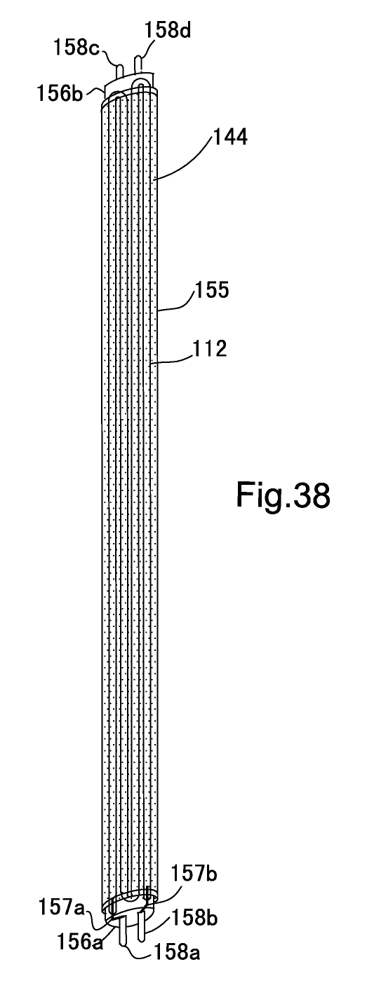

Referring to FIG. 38, a CCFL T8 tubular device is shown with a 3-U linear CCFL filament 112 housing inside the T8 light-transmitting container 155, which contains a solid light-transmitting compound 144 inside. It has two bi-pin electrical connectors 156a and 156b on each side. However, the conducting wires 157a and 157b connecting from the electrodes (not shown) of the CCFL filament 112 are residing on one side of the device, and they are connected to the two pins 158a and 158b of the same bi-pin electrical connector 156a. The other two pins 158c and 158d of the electrical connector 156b are therefore not used to connect to the electrodes of the CCFL filament 112.

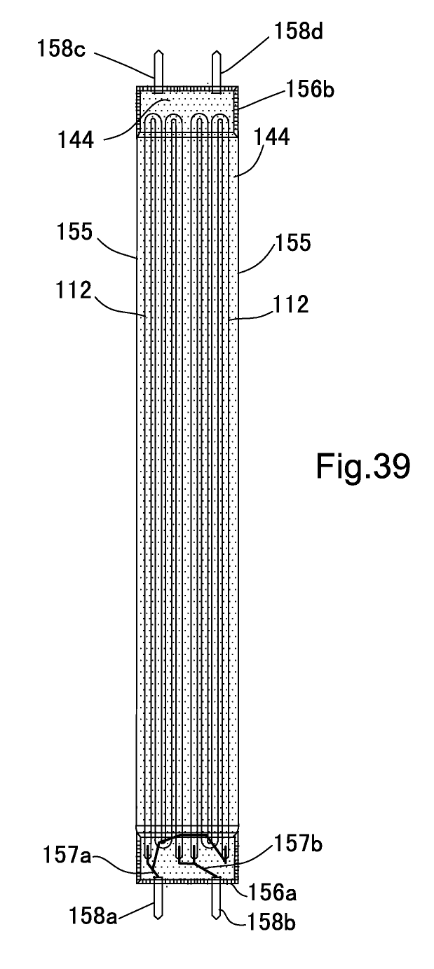

Referring to FIG. 39, it is almost the same device as that of FIG. 38, except that it is of T12 size and has two 3-U linear filaments 112 housing inside the T12 light-transmitting container 155, which contains a solid light-transmitting compound 144 inside. Again, same as the device of FIG. 38, only the pins 158a and 158b of the same bi-pin electrical connector 156a is used to conduct electricity through conducting wires 157a and 158b connected to the respective electrodes of the both CCFL filament 12, and the other bi-pin electrical connector 156b is used only for attaching to the conventional power sockets in order to support the CCFL device firmly inside the appropriate lamp fixture.

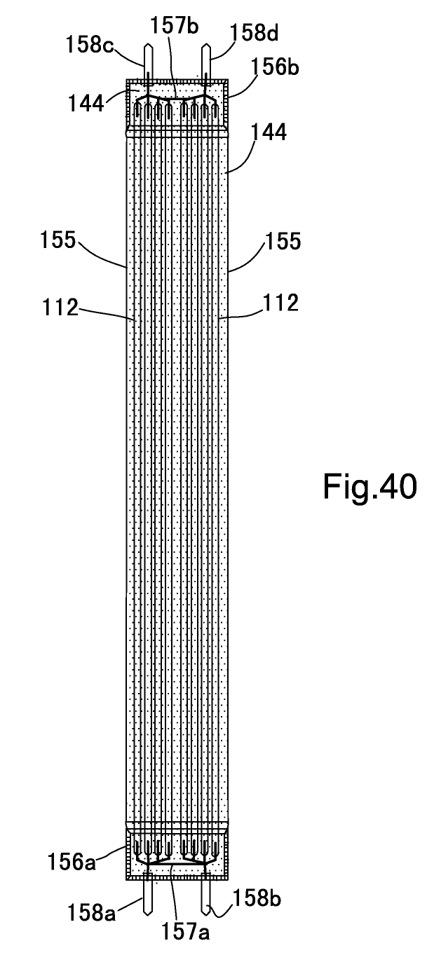

Referring to FIG. 40, it is same device as that of FIG. 39, but six linear CCFL filaments 112 are housing inside the T12 light-transmitting container 155, which contains a solid light-transmitting compound 144 inside. In this device, the plurality of electrodes on each side are connected together by conducting wires 157a and 157b, respectively, which are connected to the pins of the electrical connectors in such a manner: wire 157a is connected to one (or both) of pins 158a and 158b of bi-pin connector 156a, and wire 157b is connected to one (or both) of pins 158c and 158d of bi-pin connector 156b. As such, both electrical connectors 156a and 156b are connected to the external electronic driver (not shown) for the CCFL device, which is less convenient as the electronic driver has to be positioned in near the middle of the tubular device. However, this mode of electrical connection may be preferred by those who opt for connecting the tubular devices in the conventional HCFL style, i.e., putting the ballast at the middle of the fixture.

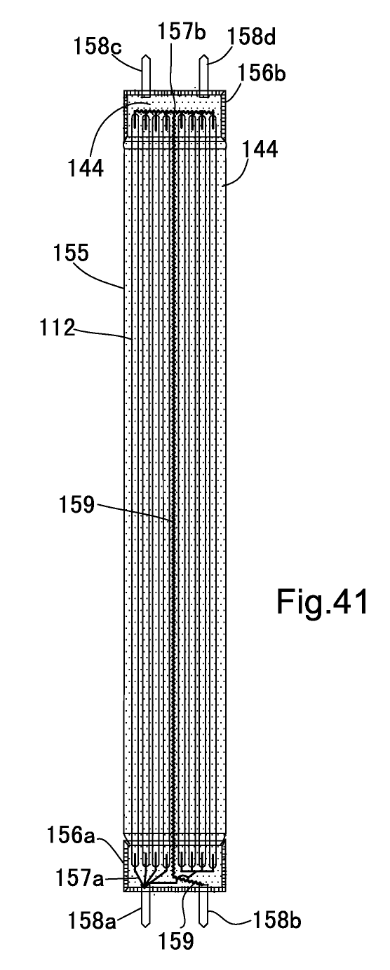

Referring to FIG. 41, it is same device as that of FIG. 40, also with six linear CCFL filaments 112 are housing inside the T12 light-transmitting container 155, which contains a solid light-transmitting compound 144 inside. In this device, the plurality of electrodes on each side are connected together by conducting wires 157a and 157b, which are connected to the pins of the electrical connectors in such a manner: wire 157a is connected to one pin 158a of bi-pin connector 156a, and wire 157b is connected via a long conducting wire 159 running through the entire length of the light-transmitting container 155 so that it is connected to pin 158b of the bi-pin connector 156a on the opposite side. As such, only electrical connector 156a is connected to the external electronic driver (not shown), which is more convenient, as the electronic driver can be placed close to the electrodes instead of at the middle of tubular container.

For each of the CCFL devices of the present invention as illustrated in FIG. 32 to FIG. 35 above, the light-transmitting container 155 may be omitted, and the hardened outer surface of the solid light-transmitting compound 144 can be directly exposed directly to air, so that the device can have better heat dissipation ability than those with light-transmitting container 155.

The CCFL plug-in, T5, T8, T9 and T12 lamps according to the present invention normally has multiple CCFL filaments inside the light-transmitting containers, and they can be of different colors on their own. As such, by using a variable color circuitry with a specially designed color switching CCFL electronic driver, the said lamp tube can produce any desirable color in any pre-determined color effects.

In the embodiment immediately above, and in other embodiments described below, there are many obvious variations for forming said CCFL device. For instance, the electronic driver can be a DA/AC or AC/AC converter, i.e., the input electricity current can be either AC or DC, and the output electricity for the CCFL is high-voltage and high-frequency electricity, with voltage of at least 80 volts and frequency of 10 k-150 kHz. The lamp base (also known as the electrical connector, especially for the Plug-in and tubular lamps) can be one of the many conventional lamp bases, which are for mechanical and electrical connection to conventional power outlets. Last but not the least, the light-transmitting container may be any shapes of the conventional incandescent light bulbs, and it can be made of glass or plastic, transparent or translucent (i.e. transmits diffuse light), or may transmit light of only certain color or colors, and it may also comprise in part an inner reflective surface. All these variations are with the scope of the present invention through the various embodiments described herein.

While the invention has been described above by reference to various embodiments, this should not be construed as a limitation on the scope of the present invention. It will be understood that changes and modifications may be made without departing from the scope of the invention, and many other variations and modifications and other uses will become apparent to those skilled in the art. Therefore, the present invention should be limited not by the specific disclosure herein, but rather by the appended claims and their legal equivalents.

1. A cold cathode fluorescent lamp device comprising:
at least one cold cathode fluorescent lamp with at least one electrode;
at least one light-transmitting container each housing said at least one lamp;
an electronic driver that is either an AC/AC or a DC/AC inverter operating said at least one lamp;
a lamp base comprising a shell with a plurality of insulated portions each has a contact electrically coupled to said electronic driver, thereby supplying either AD or DC power to said electronic driver; and
an assembly of heat-conductive compound comprising a synthetic material,
in which at least one part of said electronic driver is integrally embedded;
said assembly forms at least one surface that is connected to said shell, and
at least one part of said at least one surface connecting to said shell is exposed to air.

2. The device of claim 1, wherein:
said assembly of heat-conductive compound is connected to at least one light-transmitting container; and
said at least one lamp is attached to said assembly of heat-conductive compound, or is attached to said at least one light-transmitting container.

3. The device of claim 2, further comprising:
a gas fill of thermal conductivity better than air enclosed inside said interior space formed by the inner surfaces of said at least one light-transmitting container and said assembly of heat-conductive compound, and is in thermal contact with said at least one lamp;
wherein
said interior space is hermetically sealed;
said gas fill comprises a hydrogen, helium or neon gas, or a gas mixture with at least 1% in volume of at least one of the helium, hydrogen and neon gases; and
said gas fill has a pressure of 0.1 atmosphere (76 torr) or more at room temperature.

4. The device of claim 1, further comprising:
a container connection member that has a first opening attached to said assembly of heat-conductive compound, and has a second opening attached to said at least one light-transmitting container.

5. The device of claim 4, further comprising:
an adhesive or a bonding agent attaching said at least one lamp to an inner surface of said at least one light-transmitting container.

6. The device of claim 4, further comprising:
at least one lamp filament support member attached to said container connection member, and said at least one lamp filament support member is attaching to said at least one lamp.

7. The device of claim 4, further comprising:
at least one lamp filament support member attached to said assembly of heat-conductive compound, and said at least one lamp filament support member is attaching to said at least one lamp.

8. The device of claim 4, further comprising:
at least one lamp filament support member connected to said light-transmitting container, and said at least one lamp filament support member is attaching to said at least one lamp.

9. The device of claim 4, further comprising:
a gas fill of thermal conductivity better than air enclosed inside said interior space formed by the inner surfaces of said at least one light-transmitting container, said container connection member and said assembly of heat-conductive compound, and is in thermal contact with said at least one lamp;
wherein
said interior space is hermetically sealed;
said gas fill comprises a hydrogen, helium or neon gas, or a gas mixture with at least 1% in volume of at least one of the helium, hydrogen and neon gases; and
said gas fill has a pressure of 0.1 atmosphere (76 torr) or more at room temperature.

10. A cold cathode fluorescent lamp device comprising:
at least one cold cathode fluorescent lamp with at least one electrode;
an electronic driver that is either an AC/AC or a DC/AC inverter operating said at least one lamp;
a lamp base comprising a shell with a plurality of insulated portions each has a contact electrically coupled to said electronic driver, thereby supplying either AD or DC power to said electronic driver;
an assembly of heat-conductive compound comprising a synthetic material in which at least one part of said electronic driver is integrally embedded, said assembly forms at least one surface that is connected to said shell; and
at least one lamp filament support member attaching to and supporting said at least one lamp, wherein said at least one lamp filament support member is attaching to said assembly of heat-conductive compound.

11. The device of 10, further comprising:
a light-transmitting container that is housing said at least one lamp and is attaching to said lamp base.

12. The device of claim 11, further comprising:
a gas fill of thermal conductivity better than air enclosed inside said interior space formed by the inner surfaces of said at least one light-transmitting container, said assembly of heat-conductive compound and said lamp base, and is in thermal contact with said at least one lamp; wherein
said interior space is hermetically sealed;
said gas fill comprises a hydrogen, helium or neon gas, or a gas mixture with at least 1% in volume of at least one of the helium, hydrogen and neon gases; and
said gas fill has a pressure of 0.1 atmosphere (76 torr) or more at room temperature.

13. The device of 10, further comprising:
at least one light-transmitting container housing said at least one lamp; and
a container connection member that has a first opening attached to said at least one light-transmitting container and a second opening attached to said assembly of heat-conductive compound.

14. The device of claim 13, further comprising:
a gas fill of thermal conductivity better than air enclosed inside said interior space formed by the inner surfaces of said at least one light-transmitting container, said container connection member and said assembly of heat-conductive compound, and is in thermal contact with said at least one lamp; wherein
said interior space is hermetically sealed;
said gas fill comprises a hydrogen, helium or neon gas, or a gas mixture with at least 1% in volume of at least one of the helium, hydrogen and neon gases; and
said gas fill has a pressure of 0.1 atmosphere (76 torr) or more at room temperature.

15. The device of 13, wherein:
said at least one lamp filament support member is attached to said container connection member.

16. A cold cathode fluorescent lamp device comprising:
at least one cold cathode fluorescent lamp with at least one electrode;
at least one solid light-transmitting compound comprising a light-transmitting synthetic material, in which at least one lamp is embedded, and which is in thermal contact with said at least one lamp; and
at least one lamp base or electrical connector each comprising a shell with a plurality of insulated portions, and said at least one lamp base or electrical connector is for mechanical and electrical connection with a conventional power socket.

17. The device of claim 16, further comprising:
at least one light-transmitting container attached to said at least one solid light-transmitting compound embedding said at least one lamp, wherein
said insulated portions of said shell of said at least one lamp base or electrical connector each has at least one contact electrically coupled to said at least one electrode of said at least one lamp.

18. The device of claim 16, further comprising:
an electronic driver that is either an AC/AC or a DC/AC inverter operating said at least one lamp; and
an assembly of heat-conductive compound comprising a synthetic material in which at least one part of said electronic driver is integrally embedded and said assembly forms at least one surface that is connected to said shell of said at least one lamp base or electrical connector;
wherein:
said insulated portions of said shell of said at least one lamp base or electrical connector each has at least one contact electrically coupled to said electronic driver.

19. The device of claim 18, further comprising:
at least one light-transmitting container attached to said at least one solid light-transmitting compound embedding said at least one lamp.

20. The device of claim 16, wherein:
said at least one solid light-transmitting compound is a transparent shatter-resistant coating comprising a synthetic material such as a fluoropolymer material.
